(19) United States
(12) Patent Application Publication
(10) Pub. No.: US 2024/0372138 A1
(43) Pub. Date: Nov. 7, 2024

(54) ENERGY STORAGE APPLICATION ELECTROLYTES AND ELECTRODE COMPOSITIONS COMPRISED OF HETEROCYCLE

(71) Applicant: Zymergen Inc., Emeryville, CA (US)

(72) Inventors: John MCNAMARA, El Sobrante, CA (US); Luis Matias INIESTA-CIVERA, Oakland, CA (US)

(21) Appl. No.: 18/576,624

(22) PCT Filed: Jul. 8, 2022
(86) PCT No.: PCT/US2022/036474

§ 371 Date: Jan. 4, 2024

Related U.S. Application Data
(60) Provisional application No. 63/219,394, filed on Jul. 8, 2021.

(51) Int. Cl. H01M 10/0565; H01G 9/028; H01G 9/035; H01M 10/0567

(52) U.S. Cl. CPC H01M 10/0565; H01G 9/028; H01G 9/035; H01M 10/0567; H01M 2300/0025; H01M 2300/0082; H01M 2300/0085

(57) ABSTRACT

The present disclosure relates to polymers and additives that may be used in energy storage applications, and, more specifically, in liquid and solid state electrolytes. The present disclosure further relates to batteries and capacitors containing the electrolytes.

### CROSS-REFERENCE TO RELATED APPLICATION

The present Application claims priority to U.S. Provisional Patent Application No. 63/219,394, filed Jul. 8, 2021, the entire contents of each of which are incorporated herein by reference and relied upon.

### TECHNICAL FIELD

The present disclosure relates to polymers and additives that may be used in energy storage applications, and more specifically, in liquid and solid state electrolytes. The present disclosure further relates to batteries and capacitors containing the electrolytes.

### BACKGROUND

Renewable sources of energy (e.g., photovoltaic, eolic, and the like) that do not rely on coal, petroleum products, or natural gas are seeing increased use in a variety of applications based on their substantially reduced environmental impact. As efforts to reduce greenhouse gas emissions become even more critical, their use is expected to increase further. However, even though renewable energy sources are naturally replenishing (i.e., virtually inexhaustible), they are limited in the amount of energy that is available per unit of time. As a result, there is a need to develop new, highly efficient energy storage systems that meet the technological demands of both existing and developing applications. These storage systems should also be safe and non-toxic.

### SUMMARY

In one aspect, the present disclosure provides an electrolyte composition comprising:
a compound of Formula (I):

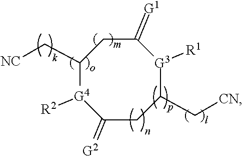

wherein
(i) G¹ and G² are independently selected from the group consisting of O, S, Se, NH, and PH;
(ii) G³ and G⁴ are independently selected from the group consisting of N and P;
(iii) R¹ and R² are independently selected from the group consisting of H, alkyl, cycloalkyl, alkenyl, cycloalkenyl, aryl, alkylenearyl, heteroaryl, alkyleneheteroaryl;
(iv) k and l are independently integers ≥0;
(v) m and n are independently selected from 0, 1, 2, 3, 4 and 5; and (vi) o and p are independently selected from 1, 2, 3, 4 and 5.

In one aspect, the present disclosure provides electrolyte compositions comprising a polymer prepared by a process comprising polymerizing a compound of Formula (I):

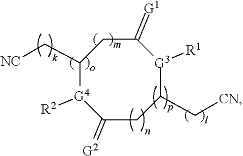

wherein
(i) G¹ and G² are independently selected from the group consisting of O, S, Se, NH, and PH;
(ii) G³ and G⁴ are independently selected from the group consisting of N and P;
(iii) R¹ and R² are independently selected from the group consisting of H, alkyl, cycloalkyl, alkenyl, cycloalkenyl, aryl, alkylenearyl, heteroaryl, alkyleneheteroaryl;
(iv) k and l are independently integers ≥0;
(v) m and n are independently selected from 0, 1, 2, 3, 4 and 5; and (vi) o and p are independently selected from 1, 2, 3, 4 and 5.

In embodiments, the compound of Formula (I) is selected from the group consisting of:

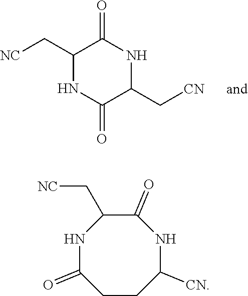 [SMILES: N#CCC1NC(=O)C(CC#N)NC1=O ; "and" ; N#CCC1NC(=O)CCC(C#N)NC1=O]

In one aspect, the present disclosure provides an electrolyte composition comprising:
a compound of Formula (II):

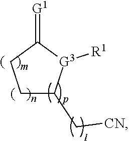

wherein
(i) G¹ is selected from the group consisting of O, S, Se, NH, and PH;
(ii) G³ is selected from the group consisting of N and P;
(iii) R¹ is selected from the group consisting of H, alkyl, cycloalkyl, alkenyl, cycloalkenyl, aryl, alkylenearyl, heteroaryl, alkyleneheteroaryl;
(iv) l is an integer ≥0;
(v) m and n are independently selected from 1, 2, 3, 4 and 5; and
(vi) p is selected from 1, 2, 3, 4 and 5.

In one aspect, the present disclosure provides electrolyte compositions comprising a polymer prepared by a process comprising polymerizing a compound of Formula (II):

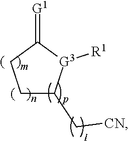

wherein
(i) G¹ is selected from the group consisting of O, S, Se, NH, and PH;
(ii) G³ is selected from the group consisting of N and P;
(iii) R¹ is selected from the group consisting of H, alkyl, cycloalkyl, alkenyl, cycloalkenyl, aryl, alkylenearyl, heteroaryl, and alkyleneheteroaryl; (iv) l is an integer ≥0;
(v) m and n are independently selected from 1, 2, 3, 4 and 5; and
(vi) p is selected from 1, 2, 3, 4 and 5.

In embodiments, the compound of Formula (II) is selected from the group consisting of:

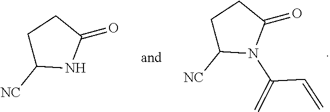

In embodiments, the compound of Formula (I) or Formula (II) is copolymerized with a compound selected from the group consisting of ethylene oxide, methacrylate, a polyether, a fluoro organic compounds, acrylonitrile, styrene, vinyl pyrrolidone, pyrrole, acrylic acid, polyphenylene sulfide, polyether ether ketone, vinyl pyridine, polyamines, polyimides, polyamides, and cyanoacrylate.

In one aspect, the present disclosure provides a battery, comprising:
(a) an anode;
(b) a cathode; and
(c) an electrolyte composition of the present disclosure operatively coupled with the anode and cathode.

In one aspect, the present disclosure provides a capacitor, comprising an electrolyte composition of the present disclosure.

### DETAILED DESCRIPTION

Energy storage is a field with a tremendous push for innovation due to the use of renewable sources of energy like photovoltaic and eolic that do not rely on coal, petroleum products or natural gas—fossil fuels that are major greenhouse gases contributors. These increasingly used renewable energy sources need electrical storage systems capable of storing the energy produced in a non-continuous fashion and releasing it when needed. In the energy storage field, rechargeable batteries are of special importance due to the portable devices market. Cost and performance of new advanced batteries are key to extend the usage of new energy sources. Applications such as hybrid and electric cars, smartphones, and wearables need batteries with higher energy and power densities, shorter charge cycles and safer systems. Currently, lithium ion batteries are the most widely used type of battery in those applications thanks to the lightness and high energy density of lithium, which confers important advantages to this type of batteries compared to Pb-acid, Ni—Cd or NiMH ones. Nevertheless, commercially available lithium ion batteries have important limitations such as safety hazards, self-discharge, and environmental toxicity among others. Some causes of these limitations are lithium metal dendrite growth that can cause short circuits and flammable organic solvent usage that can produce toxic compounds and catch fire easily.

In contrast, solid state batteries offer particular advantages. They do not contain toxic and flammable liquid organic solvents, which translates to increased safety and reduced toxicity. In addition, they have potentially higher energy and power density. The main challenge for solid state electrolytes is the ionic conductivity since ions move slower in solids than they perform in the liquid-based organic solvents. Ionic movement through the electrolyte is needed to move the electron flow in the external component of the battery. In polymer-based electrolytes, crystallinity and polymer composition determines the pace at which ions move between electrodes.

Poly(ethylene oxide) (PEO) has been considered the gold standard of polymer based solid state electrolytes due to its intrinsic ionic conductivity at high temperatures and its ability to dissolve lithium salts. Nevertheless, PEO has low ionic conductivities at room temperature (10⁻⁵ S/cm), far from the lithium ion battery ionic conductivities and what is desirable for commercial applications (10⁻³ S/cm).

Other compounds that have been tested and found successful for one or multiple property requirements are methacrylates, poly ethers, fluoro organic compounds, poly acrylonitrile, polystyrene, poly vinyl pyrrolidone, polypyrrole, polyacrylic acid, polycyanoacrylates and analogue molecules. Additives such as succinonitrile have also demonstrated ionic conductivity enhancement.

In addition to the material composition, the polymer structure plays an important role in the system performance. Some approaches consist of copolymer electrolytes with one type of material providing structural integrity and another one providing ionic conductivity. Others use additives intercalated in the polymer to enhance the ionic conductivity.

The challenge for solid state batteries consists of finding a system with properties that fill all the requirements without sacrificing a particular one. Those requirements include: high ionic conductivity (measured in S/cm), high energy and power density (in Wh/kg and W/cm²), high stability, high capacity retention (in % of retention after x number of cycles), non-flammability, high thermal stability, good mechanical properties to avoid dendrite formation (shear modulus in Pa), flexibility, being easy to produce and cheap (in $/kWh), and having high voltage (in V).

### Definitions

As used herein, the term “compound” refers to an organic molecule having molecular weight of less than 900 daltons. Throughout the present disclosure, this term can be used interchangeably with the terms “monomer” and “small molecule.” A compound referenced by name includes the ionized forms of the named compound where the compound is ionizable and includes the acid/base cognate form of the named compound where the compound is an acid or a base.

Unless context indicates otherwise, the features of the invention can be used in any combination. Any feature or combination of features set forth can be excluded or omitted. Certain features of the invention, which are described in separate embodiments may also be provided in combination in a single embodiment. Features of the invention, which are described in a single embodiment may also be provided separately or in any suitable sub-combination. All combinations of the embodiments are disclosed herein as if each and every combination were individually disclosed. All sub-combinations of the embodiments and elements are disclosed herein as if every such sub-combination were individually disclosed.

Unless defined otherwise, all technical and scientific terms used herein have the same meaning as commonly understood by one of ordinary skill in the art to which this invention belongs. The detailed description is divided into sections only for the reader's convenience and disclosure found in any section may be combined with that in another section. Although any methods and materials similar or equivalent to those described herein can also be used in the practice or testing of the present invention, the exemplary methods and materials are now described. All publications mentioned herein are incorporated by reference to disclose and describe the methods and/or materials in connection with which the publications are cited. Reference to a publication is not an admission that the publication is prior art.

The singular forms “a,” “an,” and “the” include plural referents unless the context clearly dictates otherwise.

The conjunction “and/or” means both “and” and “or,” and lists joined by “and/or” encompasses all possible combinations of one or more of the listed items.

“Alkyl” or “alkyl group” refers to a fully saturated, straight or branched hydrocarbon chain having from one to twelve carbon atoms, and which is attached to the rest of the molecule by a single bond. Alkyls comprising any number of carbon atoms from 1 to 12 are included. An alkyl comprising up to 12 carbon atoms is a C₁-C₁₂ alkyl, an alkyl comprising up to 10 carbon atoms is a C₁-C₁₀ alkyl, an alkyl comprising up to 6 carbon atoms is a C₁-C₆ alkyl and an alkyl comprising up to 5 carbon atoms is a C₁-C₅ alkyl. A C₁-C₅ alkyl includes C₅ alkyls, C₄ alkyls, C₃ alkyls, C₂ alkyls and C₁ alkyl (i.e., methyl). A C₁-C₆ alkyl includes all moieties described above for C₁-C₅ alkyls but also includes C₆ alkyls. A C₁-C₁₀ alkyl includes all moieties described above for C₁-C₅ alkyls and C₁-C₆ alkyls, but also includes C₇, C₈, C₉ and C₁₀ alkyls. Similarly, a C₁-C₁₂ alkyl includes all the foregoing moieties, but also includes C₁₁ and C₁₂ alkyls. Non-limiting examples of C₁-C₁₂ alkyl include methyl, ethyl, n-propyl, i-propyl, sec-propyl, n-butyl, i-butyl, sec-butyl, t-butyl, n-pentyl, t-amyl, n-hexyl, n-heptyl, n-octyl, n-nonyl, n-decyl, n-undecyl, and n-dodecyl. Unless stated otherwise specifically in the specification, an alkyl group can be optionally substituted.

“Alkylene” or “alkylene chain” refers to a fully saturated, straight or branched divalent hydrocarbon chain radical, and having from one to twelve carbon atoms. Non-limiting examples of C₁-C₁₂ alkylene include methylene, ethylene, propylene, n-butylene, and the like. The alkylene chain is attached to the rest of the molecule through a single bond and to a radical group (e.g., those described herein) through a single bond. The points of attachment of the alkylene chain to the rest of the molecule and to the radical group can be through one carbon or any two carbons within the chain. Unless stated otherwise specifically in the specification, an alkylene chain can be optionally substituted.

“Alkenyl” or “alkenyl group” refers to a straight or branched hydrocarbon chain having from two to twelve carbon atoms, and having one or more carbon-carbon double bonds. Each alkenyl group is attached to the rest of the molecule by a single bond. Alkenyl group comprising any number of carbon atoms from 2 to 12 are included. An alkenyl group comprising up to 12 carbon atoms is a C₂-C₁₂ alkenyl, an alkenyl comprising up to 10 carbon atoms is a C₂-C₁₀ alkenyl, an alkenyl group comprising up to 6 carbon atoms is a C₂-C₆ alkenyl and an alkenyl comprising up to 5 carbon atoms is a C₂-C₅ alkenyl. A C₂-C₅ alkenyl includes C₅ alkenyls, C₄ alkenyls, C₃ alkenyls, and C₂ alkenyls. A C₂-C₆ alkenyl includes all moieties described above for C₂-C₅ alkenyls but also includes C₆ alkenyls. A C₂-C₁₀ alkenyl includes all moieties described above for C₂-C₅ alkenyls and C₂-C₆ alkenyls, but also includes C₇, C₈, C₉ and C₁₀ alkenyls. Similarly, a C₂-C₁₂ alkenyl includes all the foregoing moieties, but also includes C₁₁ and C₁₂ alkenyls. Non-limiting examples of C₂-C₁₂ alkenyl include ethenyl (vinyl), 1-propenyl, 2-propenyl (allyl), iso-propenyl, 2-methyl-1-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-dodecenyl, 2-dodecenyl, 3-dodecenyl, 4-dodecenyl, 5-dodecenyl, 6-dodecenyl, 7-dodecenyl, 8-dodecenyl, 9-dodecenyl, 10-dodecenyl, and 11-dodecenyl. Unless stated otherwise specifically in the specification, an alkyl group can be optionally substituted.

“Aryl” refers to a hydrocarbon ring system comprising hydrogen, 6 to 18 carbon atoms and at least one aromatic ring, and which is attached to the rest of the molecule by a single bond. For purposes of this disclosure, the aryl can be a monocyclic, bicyclic, tricyclic or tetracyclic ring system, which can include fused or bridged ring systems. Aryls include, but are not limited to, aryls derived from aceanthrylene, acenaphthylene, acephenanthrylene, anthracene, azulene, benzene, chrysene, fluoranthene, fluorene, as-indacene, s-indacene, indane, indene, naphthalene, phenalene, phenanthrene, pleiadene, pyrene, and triphenylene. Unless stated otherwise specifically in the specification, the “aryl” can be optionally substituted.

“Cycloalkyl” refers to a stable non-aromatic monocyclic or polycyclic fully saturated hydrocarbon consisting solely of carbon and hydrogen atoms, which can include fused or bridged ring systems, having from three to twenty carbon atoms (e.g., having from three to ten carbon atoms) and which is attached to the rest of the molecule by a single bond. Monocyclic cycloalkyls include, for example, cyclopropyl, cyclobutyl, cyclopentyl, cyclohexyl, cycloheptyl, and cyclooctyl. Polycyclic cycloalkyls include, for example, adamantyl, norbornyl, decalinyl, 7,7-dimethyl-bicyclo[2.2.1]heptanyl, and the like. Unless otherwise stated specifically in the specification, a cycloalkyl group can be optionally substituted.

“Cycloalkenyl” refers to a stable non-aromatic monocyclic or polycyclic hydrocarbon consisting solely of carbon and hydrogen atoms, having one or more carbon-carbon double bonds, which can include fused or bridged ring systems, having from three to twenty carbon atoms, preferably having from three to ten carbon atoms, and which is attached to the rest of the molecule by a single bond. Monocyclic cycloalkenyls include, for example, cyclopentenyl, cyclohexenyl, cycloheptenyl, cycloctenyl, and the like. Polycyclic cycloalkenyls include, for example, bicyclo[2.2.1]hept-2-enyl and the like. Unless otherwise stated specifically in the specification, a cycloalkenyl group can be optionally substituted.

“Heterocyclyl,” “heterocyclic ring” or “heterocycle” refers to a stable saturated, unsaturated, or aromatic 3- to 20-membered ring which consists of two to nineteen carbon atoms and from one to six heteroatoms selected from the group consisting of nitrogen, oxygen and sulfur, and which is attached to the rest of the molecule by a single bond. Heterocyclyl or heterocyclic rings include heteroaryls, heterocyclylalkyls, heterocyclylalkenyls, and hetercyclylalkynyls. Unless stated otherwise specifically in the specification, the heterocyclyl can be a monocyclic, bicyclic, tricyclic or tetracyclic ring system, which can include fused or bridged ring systems; and the nitrogen, carbon or sulfur atoms in the heterocyclyl can be optionally oxidized; the nitrogen atom can be optionally quaternized; and the heterocyclyl can be partially or fully saturated. Examples of such heterocyclyl include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, a heterocyclyl group can be optionally substituted.

“Heteroaryl” refers to a 5- to 20-membered ring system comprising hydrogen atoms, one to nineteen carbon atoms, one to six heteroatoms selected from the group consisting of nitrogen, oxygen and sulfur, at least one aromatic ring, and which is attached to the rest of the molecule by a single bond. For purposes of this disclosure, the heteroaryl can be a monocyclic, bicyclic, tricyclic or tetracyclic ring system, which can include fused or bridged ring systems; and the nitrogen, carbon or sulfur atoms in the heteroaryl can be optionally oxidized; the nitrogen atom can be optionally quaternized. Examples include, but are not limited to, azepinyl, acridinyl, benzimidazolyl, benzothiazolyl, benzindolyl, benzodioxolyl, benzofuranyl, benzooxazolyl, benzothiazolyl, benzothiadiazolyl, benzo[b][1,4]dioxepinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzotriazolyl, benzo[4,6]imidazo[1,2-a]pyridinyl, carbazolyl, cinnolinyl, dibenzofuranyl, dibenzothiophenyl, furanyl, furanonyl, isothiazolyl, imidazolyl, indazolyl, indolyl, indazolyl, isoindolyl, indolinyl, isoindolinyl, isoquinolyl, indolizinyl, isoxazolyl, naphthyridinyl, oxadiazolyl, 2-oxoazepinyl, oxazolyl, oxiranyl, 1-oxidopyridinyl, 1-oxidopyrimidinyl, 1-oxidopyrazinyl, 1-oxidopyridazinyl, 1-phenyl-1H-pyrrolyl, phenazinyl, phenothiazinyl, phenoxazinyl, phthalazinyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, tetrahydroquinolinyl, thiazolyl, thiadiazolyl, triazolyl, tetrazolyl, triazinyl, and thiophenyl (i.e. thienyl). Unless stated otherwise specifically in the specification, a heteroaryl group can be optionally substituted.

“Alkylenearyl” refers to a radical of the formula —Rᵢ—Rⱼ, wherein Rᵢ is an alkylene and Rⱼ is an aryl, each of which is as defined herein. Unless stated otherwise specifically in this specification, an alkylenearyl group can be optionally substituted.

“Alkyleneheteroaryl” refers to a radical of the formula —Rᵢ—Rⱼ, wherein Rᵢ is an alkylene and Rⱼ is a heteroaryl, each of which is as defined herein. Unless stated otherwise specifically in this specification, an alkyleneheteroaryl group can be optionally substituted.

The term “substituted” used herein means any of the groups described herein (e.g., alkyl, alkenyl, alkynyl, alkoxy, aryl, aralkyl, carbocyclyl, cycloalkyl, cycloalkenyl, cycloalkynyl, haloalkyl, heterocyclyl, and/or heteroaryl) wherein at least one hydrogen atom is replaced by a bond to a non-hydrogen atoms such as, but not limited to: a halogen atom such as F, Cl, Br, and I; an oxygen atom in groups such as hydroxyl groups, alkoxy groups, and ester groups; a sulfur atom in groups such as thiol groups, thioalkyl groups, sulfone groups, sulfonyl groups, and sulfoxide groups; a nitrogen atom in groups such as amines, amides, alkylamines, dialkylamines, arylamines, alkylarylamines, diarylamines, N-oxides, imides, and enamines; a silicon atom in groups such as trialkylsilyl groups, dialkylarylsilyl groups, alkyldiarylsilyl groups, and triarylsilyl groups; and other heteroatoms in various other groups. “Substituted” also means any of the above groups in which one or more hydrogen atoms are replaced by a higher-order bond (e.g., a double- or triple-bond) to a heteroatom such as oxygen in oxo, carbonyl, carboxyl, and ester groups; and nitrogen in groups such as imines, oximes, hydrazones, and nitriles. For example, “substituted” includes any of the above groups in which one or more hydrogen atoms are replaced with —NR_{g}Rₕ, —NR_{g}C(═O)Rₕ, —NR_{g}C(═O)NR_{g}Rₕ, —NR_{g}C(═O)ORₕ, —NR_{g}SO₂R h, —OC(═O)NR_{g}Rₕ, —OR_{g}, —SR_{g}, —SOR_{g}, —SO₂R_{g}, —OSO₂R_{g}, —SO₂OR_{g}, ═NSO₂R_{g}, and —SO₂NR_{g}Rₕ. “Substituted” also means any of the above groups in which one or more hydrogen atoms are replaced with —C(═O)R_{g}, —C(═O)OR_{g}, —C(═O)NR_{g}Rₕ, —CH₂SO₂R_{g}, —CH₂SO₂NR_{g}Rₕ. In the foregoing, R_{g} and Rₕ are the same or different and independently hydrogen, alkyl, alkenyl, alkynyl, alkoxy, alkylamino, thioalkyl, aryl, aralkyl, cycloalkyl, cycloalkenyl, cycloalkynyl, cycloalkylalkyl, haloalkyl, haloalkenyl, haloalkynyl, heterocyclyl, N-heterocyclyl, heterocyclylalkyl, heteroaryl, N-heteroaryl and/or heteroarylalkyl. “Substituted” further means any of the above groups in which one or more hydrogen atoms are replaced by a bond to an amino, cyano, hydroxyl, imino, nitro, oxo, thioxo, halo, alkyl, alkenyl, alkynyl, alkoxy, alkylamino, thioalkyl, aryl, aralkyl, cycloalkyl, cycloalkenyl, cycloalkynyl, cycloalkylalkyl, haloalkyl, haloalkenyl, haloalkynyl, heterocyclyl, N-heterocyclyl, heterocyclylalkyl, heteroaryl, N-heteroaryl and/or heteroarylalkyl group. In addition, each of the foregoing substituents can also be optionally substituted with one or more of the above substituents.

### Electrolyte Compositions Containing Additives of the Present Disclosure:

In one aspect, the present disclosure provides electrolyte compositions comprising a Compound of Formula (I) or a Compound of Formula (II) and mixtures thereof. The compounds of Formula (I) and (II) are additives that when added to an electrolyte composition improve the performance characteristics (such as, enhancing conductivity and/or reducing crystallinity). The Compounds of Formula (I) or Formula (II) may be added to any appropriate electrolyte composition known to those skilled in the art.

In embodiments, the present disclosure provides an electrolyte composition comprising:
a compound of Formula (I):

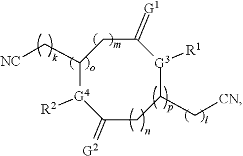

wherein
i. G¹ and G² are independently selected from the group consisting of O, S, Se, NH, and PH;
ii. G³ and G⁴ are independently selected from the group consisting of N and P;
iii. R¹ and R² are independently selected from the group consisting of H, alkyl, cycloalkyl, alkenyl, cycloalkenyl, aryl, alkylenearyl, heteroaryl, alkyleneheteroaryl;
iv. k and l are independently integers ≥0;
v. m and n are independently selected from 0, 1, 2, 3, 4 and 5; and
vi. o and p are independently selected from 1, 2, 3, 4 and 5.

In embodiments of Formula (I), G¹ and G² are O. In embodiments, G¹ is NH and G² is O. In embodiments, G¹ is O and G² is NH. In embodiments, G¹ is S and G² is O. In embodiments, G¹ is O and G² is S.

In embodiments of Formula (I), G³ and G⁴ are N. In embodiments, G³ is N and G⁴ is P. In embodiments, G³ is P and G⁴ is N.

In embodiments of Formula (I), R¹ and R² are independently selected from the group consisting of H, alkyl, and cycloalkyl. In embodiments, R¹ and R² are independently selected from the group consisting of H and alkyl. In embodiments, R¹ and R² are H. In embodiments, R¹ is H and R² is alkyl. In embodiments, R¹ is alkyl and R² is H.

In embodiments of Formula (I), k and l are independently an integer from 0-4. In embodiments, k and l are independently an integer from 0-3. In embodiments, k and 1 are independently an integer from 0-2. In embodiments, k and l are independently selected from 0 and 1. In embodiments, k and l are 0. In embodiments, k and l are 1. In embodiments, k is 0 and 1 is 1. In embodiments, k is 1 and 1 is 0.

In embodiments of Formula (I), m and n are 0. In embodiments, m is 0 and n is 1. In embodiments, m is 1 and n is 0. In embodiments, m is 0 and n is 2. In embodiments, m is 2 and n is 0. In embodiments, m and n are 1. In embodiments, m and n are 2.

In embodiments of Formula (I), o and p are 1. In embodiments, o is 1 and p is 2. In embodiments, o is 2 and p is 1. In embodiments, o and p are 2.

In embodiments, the compound of Formula (I) is a 6-membered heterocyclyl ring, as defined by the values of m, n, o, and p. In embodiments of Formula (I), m is 0,
n is 0, o is 1, and p is 1.

In embodiments, the compound of Formula (I) is a 8-membered heterocyclyl ring, as defined by the values of m, n, o, and p. In embodiments of Formula (I), m is 1,
n is 1, o is 1, and p is 1.

In embodiments, the compound of Formula (I) is selected from the group consisting of:

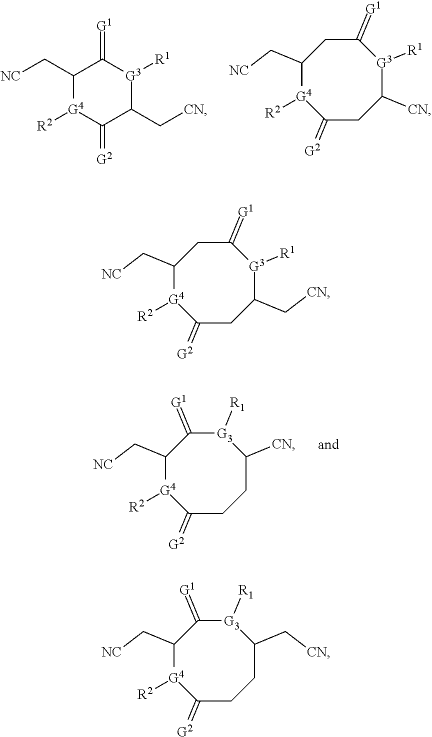

wherein G¹, G², G³, G⁴, R¹, and R² are as defined above.

In embodiments, the compound of Formula (I) is selected from the group consisting of:

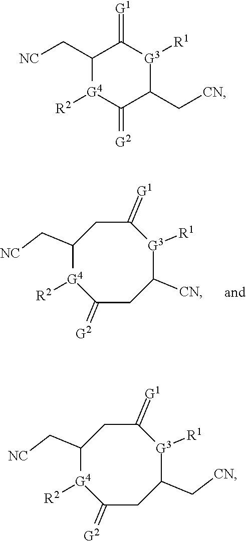

wherein G¹, G², G³, G⁴, R¹, and R² are as defined above.

In embodiments, the compound of Formula (I) is:

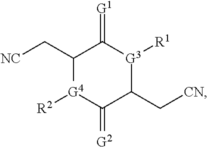

wherein G¹, G², G³, G⁴, R¹, and R² are as defined above.

In embodiments, the compound of Formula (I) is:

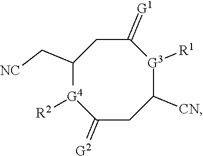

wherein G¹, G², G³, G⁴, R¹, and R² are as defined above.

In embodiments, the compound of Formula (I) is:

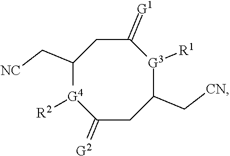

wherein G¹, G², G³, G⁴, R¹, and R² are as defined above.

In embodiments, the compound of Formula (I) is:

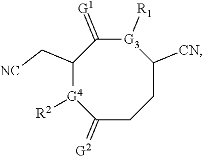

wherein G¹, G², G³, G⁴, R¹, and R² are as defined above.

In embodiments, the compound of Formula (I) is:

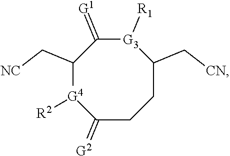

wherein G¹, G², G³, G⁴, R¹, and R² are as defined above.

In embodiments, the compound of Formula (I) is selected from the group consisting of:

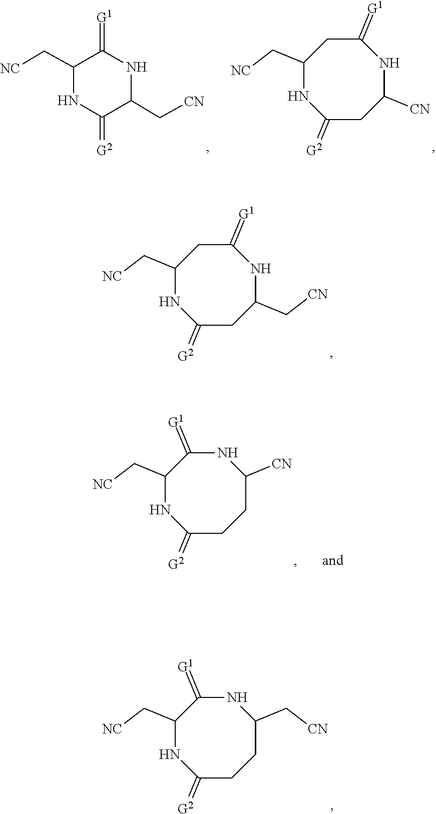

wherein G¹ and G² are as defined above.

In embodiments, the compound of Formula (I) is:

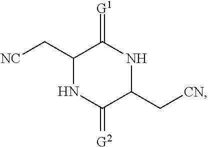

wherein G¹ and G² are as defined above.

In embodiments, the compound of Formula (I) is:

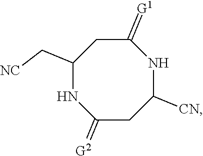

wherein G¹ and G² are as defined above.

In embodiments, the compound of Formula (I) is:

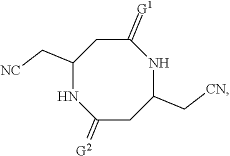

wherein G¹ and G² are as defined above.

In embodiments, the compound of Formula (I) is:

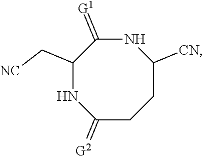

wherein G¹ and G² are as defined above.

In embodiments, the compound of Formula (I) is:

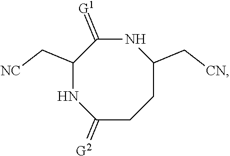

wherein G¹ and G² are as defined above.

In embodiments, the compound of Formula (I) is selected from the group consisting of:

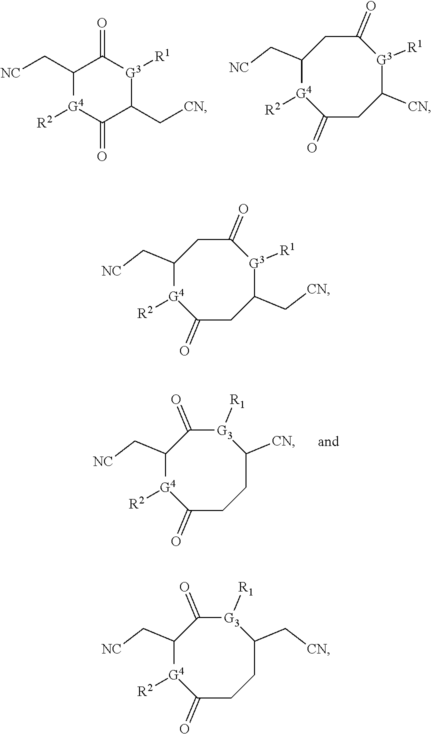

wherein G³, G⁴, R¹, and R² are as defined above.

In embodiments, the compound of Formula (I) is:

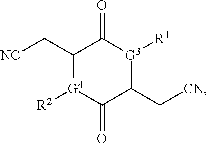

wherein G³a G⁴, R¹, and R² are as defined above.

In embodiments, the compound of Formula (I) is:

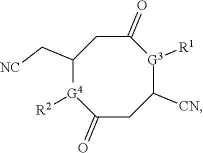

wherein G³, G⁴, R¹, and R² are as defined above.

In embodiments, the compound of Formula (I) is:

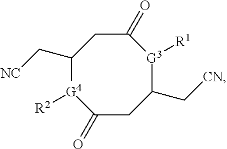

wherein G³, G⁴, R¹, and R² are as defined above.

In embodiments, the compound of Formula (I) is:

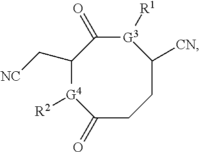

wherein G³, G⁴, R¹, and R² are as defined above.

In embodiments, the compound of Formula (I) is:

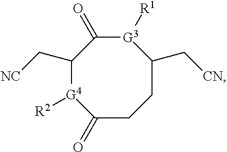

wherein G³, G⁴, R¹, and R² are as defined above.

In embodiments, the compound of Formula (I) is selected from the group consisting of:

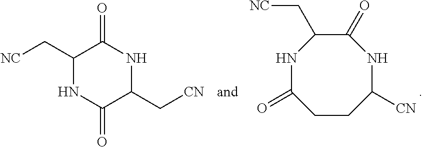 [SMILES: N#CCC1NC(=O)C(CC#N)NC1=O ; "and" ; N#CCC1NC(=O)CCC(C#N)NC1=O ; "."]

In embodiments, the compound of Formula (I) is:

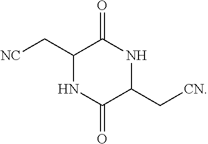 [SMILES: N#CCC1NC(=O)C(CC#N)NC1=O]

In embodiments, the compound of Formula (I) is:

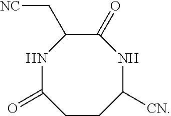 [SMILES: N#CCC1NC(=O)CCC(C#N)NC1=O]

In embodiments, the present disclosure provides an electrolyte composition comprising:
a compound of Formula (II):

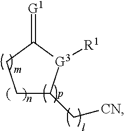

wherein
i. G¹ is selected from the group consisting of O, S, Se, NH, and PH;
ii. G³ is selected from the group consisting of N and P;
iii. R¹ is selected from the group consisting of H, alkyl, cycloalkyl, alkenyl, cycloalkenyl, aryl, alkylenearyl, heteroaryl, alkyleneheteroaryl;
iv. l is an integer ≥0;
v. m and n are independently selected from 1, 2, 3, 4 and 5; and
vi. p is selected from 1, 2, 3, 4 and 5.

In embodiments of Formula (II), G¹ is 0, S, or NH. In embodiments, G¹ is O or S. In embodiments, G¹ is O.

In embodiments of Formula (II), G³ is N.

In embodiments of Formula (II), R¹ is selected from the group consisting of H, alkyl, and alkenyl.

In embodiments of Formula (II), l is an integer from 0 to 2. In embodiments, 1 is 0. In embodiments, 1 is 1. In embodiments, 1 is 2.

In embodiments of Formula (II), m and n are 1.

In embodiments of Formula (II), p is 1.

In embodiments, the compound of Formula (II) is selected from the group consisting of:

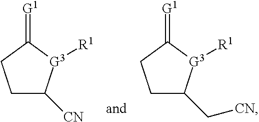

wherein G¹, G³, and R¹ are as defined above.

In embodiments, the compound of Formula (II) is:

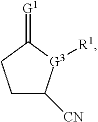

wherein G¹, G³, and R¹ are as defined above.

In embodiments, the compound of Formula (II) is:

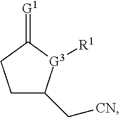

wherein G¹, G³, and R¹ are as defined above.

In embodiments, the compound of Formula (II) is selected from the group consisting of:

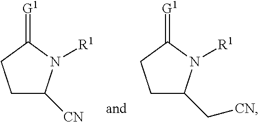

wherein G¹ and R¹ are as defined above.

In embodiments, the compound of Formula (II) is:

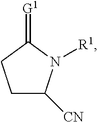

wherein G¹ and R¹ are as defined above.

In embodiments, the compound of Formula (II) is:

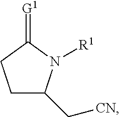

wherein G¹ and R¹ are as defined above.

In embodiments, the compound of Formula (II) is:

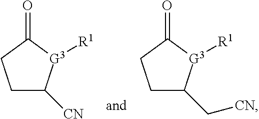

wherein G³ and R¹ are as defined above.

In embodiments, the compound of Formula (II) is:

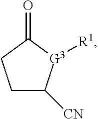

wherein G³ and R¹ are as defined above.

In embodiments, the compound of Formula (II) is:

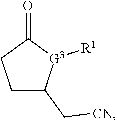

wherein G³ and R¹ are as defined above.

In embodiments, the compound of Formula (II) is selected from the group consisting of:

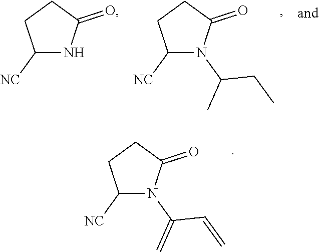

In embodiments, the compound of Formula (II) is:

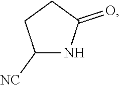

In embodiments, the compound of Formula (II) is:

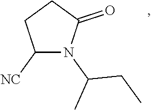

In embodiments, the compound of Formula (II) is:

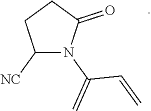

### Homopolymers of the Present Disclosure:

In one aspect, the present disclosure provides homopolymers of a Compound of Formula (I) or a Compound of Formula (II). The homopolymers of the present disclosure are conductivity enhancing polymers. The homopolymers of the present disclosure may be used as an electrolyte composition or may be added to any appropriate electrolyte composition known in the art. The compounds of Formula (I) or Formula (II) may be polymerized using methods that are known to those skilled in the art including addition (chain-reaction) polymerization and condensation (step-reaction) polymerization. In embodiments, the polymerization is cationic polymerization. In embodiments, the polymerization is anionic polymerization. In still other embodiments, the polymerization is radical polymerization.

In embodiments, the present disclosure provides a homopolymer, wherein the homopolymer is prepared by a process comprising polymerizing a compound of Formula (I):

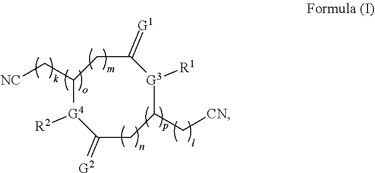

wherein G¹, G², G³, G⁴, R¹, R², k, 1, m, n, o, and p are as defined above.

As understood by one of skill in the art, the homopolymers of the present disclosure comprise a polymer comprising identical repeating monomeric units provided by the compounds of Formula (I), above. For example, a homopolymer electrolyte may be represented by the following formula:

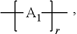

wherein A₁ is a monomer provided by a compound of Formula (I), and wherein r is an integer from 3 to 10,000.

In embodiments, the present disclosure provides a homopolymer prepared by a process comprising polymerizing a compound of Formula (I), wherein the compound of Formula (I) is selected from the group consisting of:

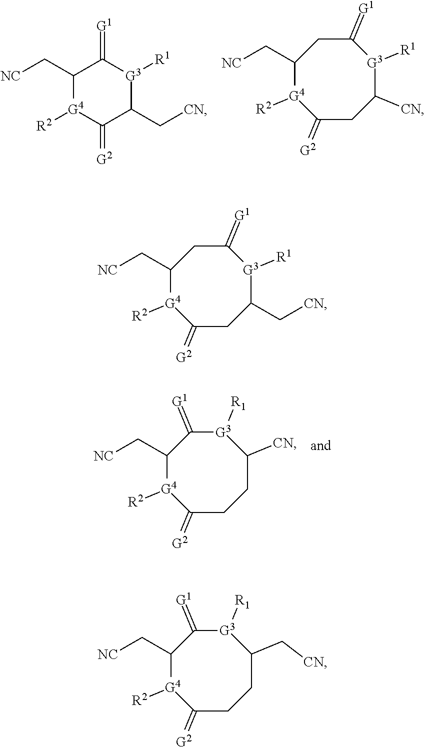

wherein G¹, G², G³, G⁴, R¹, and R² are as defined above.

In embodiments, the present disclosure provides a homopolymer prepared by a process comprising polymerizing a compound of Formula (I), wherein the compound of Formula (I) is selected from the group consisting of:

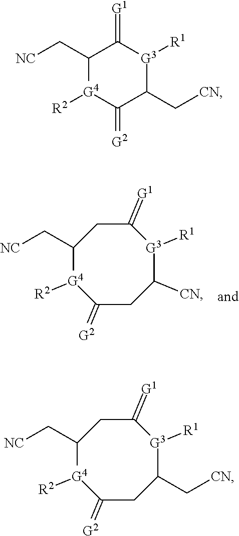

wherein G¹, G², G³, G⁴, R¹, and R² are as defined above.

In embodiments, the present disclosure provides a homopolymer prepared by a process comprising polymerizing a compound of Formula (I), wherein the compound of Formula (I) is selected from the group consisting of:

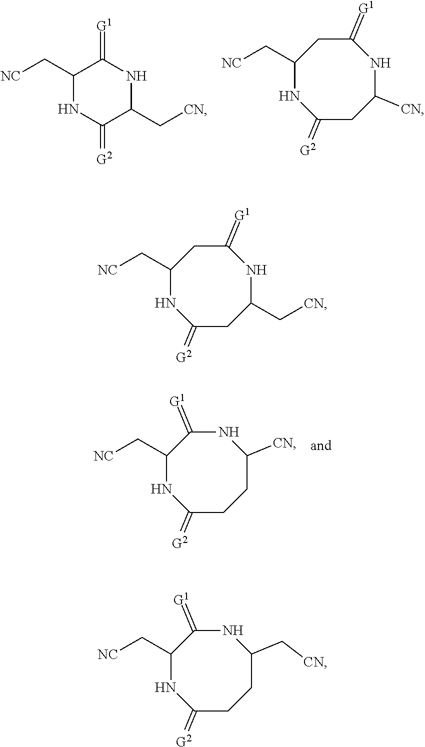

wherein G¹ and G² are as defined above.

In embodiments, the present disclosure provides a homopolymer prepared by a process comprising polymerizing a compound of Formula (I), wherein the compound of Formula (I) is selected from the group consisting of:

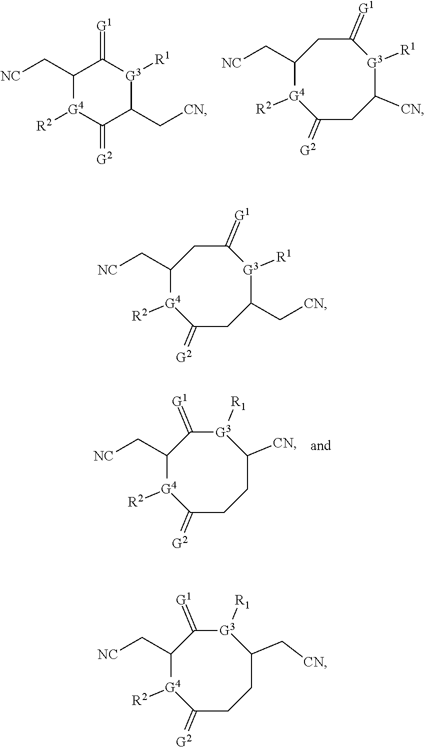

wherein G³, G⁴, R¹, and R² are as defined above.

In embodiments, the present disclosure provides a homopolymer prepared by a process comprising polymerizing a compound of Formula (I), wherein the compound of Formula (I) is selected from the group consisting of:

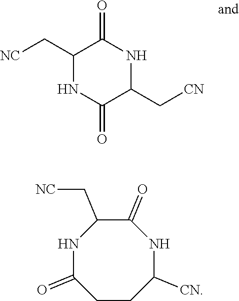 [SMILES: N#CCC1NC(=O)C(CC#N)NC1=O ; N#CCC1NC(=O)CCC(C#N)NC1=O]

In embodiments, the present disclosure provides a homopolymer prepared by a process comprising polymerizing a compound of Formula (I):

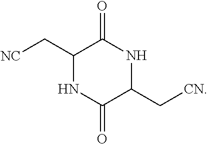 [SMILES: N#CCC1NC(=O)C(CC#N)NC1=O]

In embodiments, the present disclosure provides a homopolymer prepared by a process comprising polymerizing a compound of Formula (I):

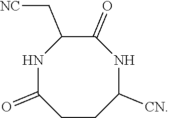 [SMILES: N#CCC1NC(=O)CCC(C#N)NC1=O]

In embodiments, the present disclosure provides a homopolymer, wherein the homopolymer is prepared by a process comprising polymerizing a compound of Formula (II):

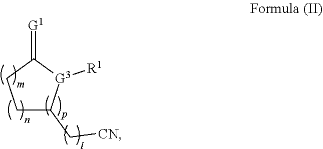

wherein G¹, G³, R¹, 1, m, n, and p are as defined above.

In embodiments, the present disclosure provides a homopolymer prepared by a process comprising polymerizing a compound of Formula (II), wherein the compound of Formula (II) is selected from the group consisting of:

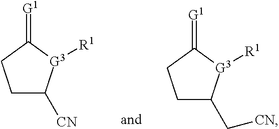

wherein G¹, G³, and R¹ are as defined above.

In embodiments, the present disclosure provides a homopolymer prepared by a process comprising polymerizing a compound:

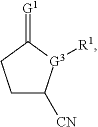

wherein G¹, G³, and R¹ are as defined above.

In embodiments, the present disclosure provides a homopolymer prepared by a process comprising polymerizing a compound:

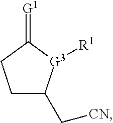

wherein G¹, G³, and R¹ are as defined above.

In embodiments, the present disclosure provides a homopolymer prepared by a process comprising polymerizing a compound of Formula (II), wherein the compound of Formula (II) is selected from the group consisting of:

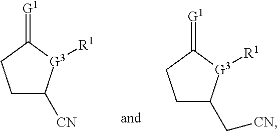

wherein G¹ and R¹ are as defined above.

In embodiments, the present disclosure provides a homopolymer prepared by a process comprising polymerizing a compound:

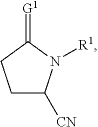

wherein G¹ and R¹ are as defined above.

In embodiments, the present disclosure provides a homopolymer prepared by a process comprising polymerizing a compound:

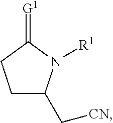

wherein G¹ and R¹ are as defined above.

In embodiments, the present disclosure provides a homopolymer prepared by a process comprising polymerizing a compound of Formula (II), wherein the compound of Formula (II) is selected from the group consisting of:

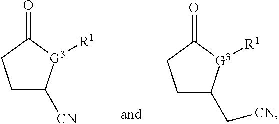

wherein G³ and R¹ are as defined above.

In embodiments, the present disclosure provides a homopolymer prepared by a process comprising polymerizing a compound:

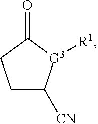

wherein G³ and R¹ are as defined above.

In embodiments, the present disclosure provides a homopolymer prepared by a process comprising polymerizing a compound:

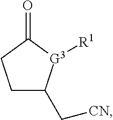

wherein G³ and R¹ are as defined above.

In embodiments, the present disclosure provides a homopolymer prepared by a process comprising polymerizing a compound selected from the group consisting of:

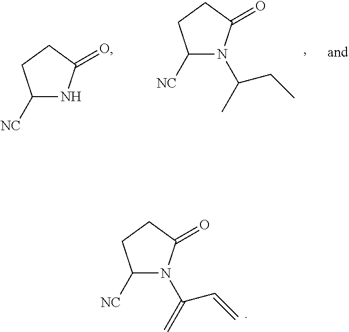

In embodiments, the present disclosure provides a homopolymer prepared by a process comprising polymerizing a compound selected from the group consisting of:

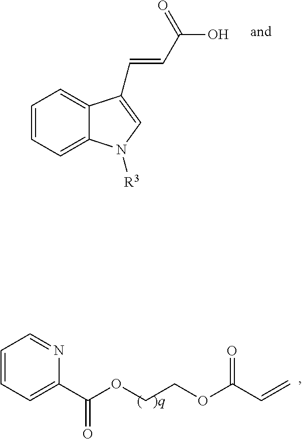

wherein R³ is H or alkyl, and q is an integer from 1-4.

In embodiments, the present disclosure provides a homopolymer prepared by a process comprising polymerizing a compound selected from the group consisting of:

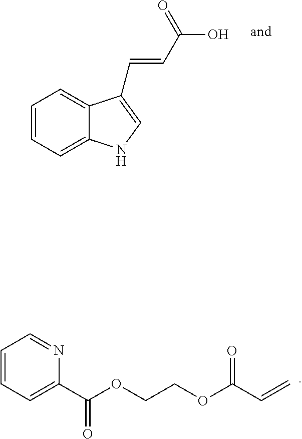 [SMILES: O=C(O)/C=C/c1c[nH]c2ccccc12 ; C=CC(=O)OCCOC(=O)c1ccccn1]

In embodiments, the homopolymers of the present disclosure are characterized by a uniform dispersity (D). In embodiments, the homopolymers are characterized by a non-uniform dispersity. In embodiments, the homopolymers are characterized by a D from about 1 to about 20, e.g., about 1, about 2, about 3, about 4, about 5, about 6, about 7, about 8, about 9, about 10, about 11, about 12, about 13, about 14, about 15, about 16, about 17, about 18, about 19, or about 20.

In embodiments, the homopolymer is solid polymer electrolyte (SPE). In embodiments, the homopolymer is a liquid polymer electrolyte.

### Heteropolymers of the Present Disclosure:

In one aspect, the present disclosure provides heteropolymers of Compound of Formula (I) or a Compound of Formula (II) and mixtures thereof. The heteropolymers of the present disclosure may be used as an electrolyte composition or added to any appropriate electrolyte composition known in the art. The compounds may be polymerized using methods that are known to those skilled in the art.

In embodiments, the heteropolymers comprise two or more different compounds of Formula (I) (i.e., two or more Compounds of Formula (I) where the definitions of the groups G¹, G², G³, G⁴, R¹, R², k, 1, m, n, o, and p are not the same). In embodiments, monomers are polymerized to form a heteropolymer of the present disclosure.

In embodiments, the present disclosure provides a heteropolymer, wherein the heteropolymer is prepared by a process comprising polymerizing:
two or more compounds of Formula (I):

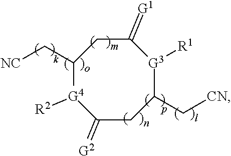

wherein G¹, G², G³, G⁴, R¹, R², k, 1, m, n, o, and p are as defined above.

As understood by one of skill in the art, a heteropolymer of the present disclosure comprises a polymer comprising two or more non-identical compounds of Formula (I), above. For example, the heteropolymer may be represented by formulas including, but not limited to:

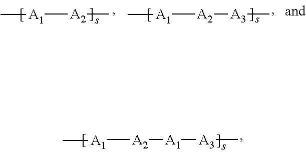

wherein A₁, A₂, and A₃ are different monomers of Formula (I), and wherein s is an integer from 3 to 10,000.

In embodiments, the present disclosure provides a heteropolymer, wherein the heteropolymer is prepared by a process comprising polymerizing two or more compounds selected from the group consisting of:

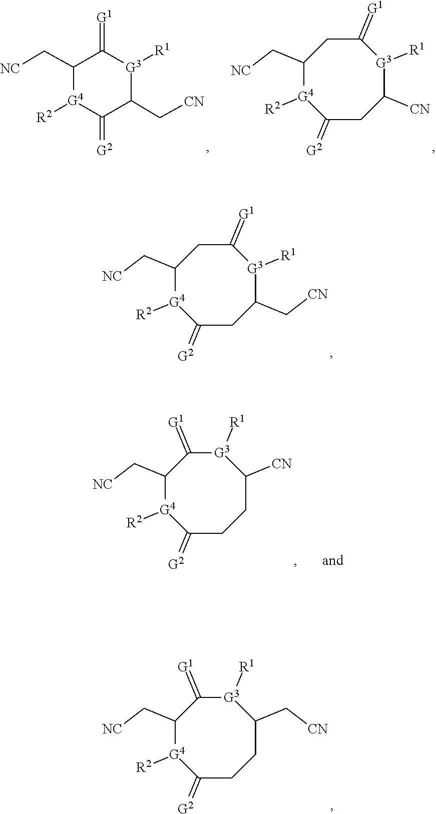

wherein G¹, G², G³, G⁴, R¹, and R² are as defined above.

In embodiments, the present disclosure provides a heteropolymer, wherein the heteropolymer is prepared by a process comprising polymerizing two or more compounds selected from the group consisting of:

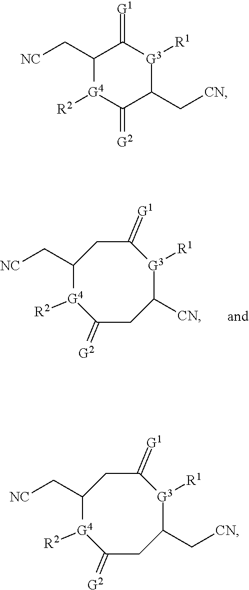

wherein G¹, G², G³, G⁴, R¹, and R² are as defined above.

In embodiments, the present disclosure provides a heteropolymer, wherein the heteropolymer is prepared by a process comprising polymerizing two or more compounds selected from the group consisting of:

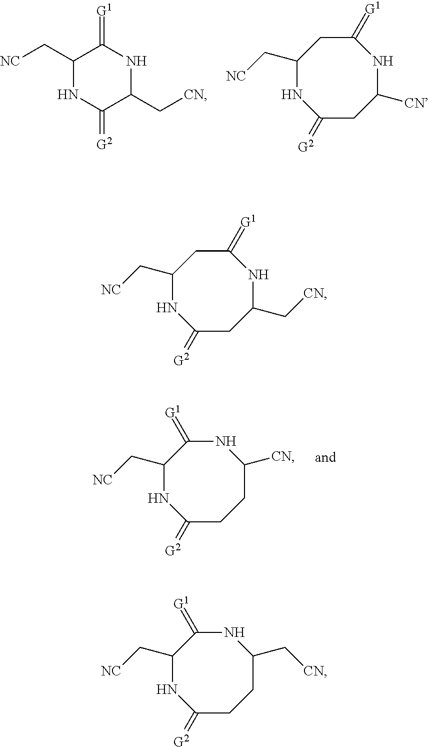

wherein G¹ and G² are as defined above.

In embodiments, the present disclosure provides a heteropolymer, wherein the heteropolymer is prepared by a process comprising polymerizing two or more compounds selected from the group consisting of:

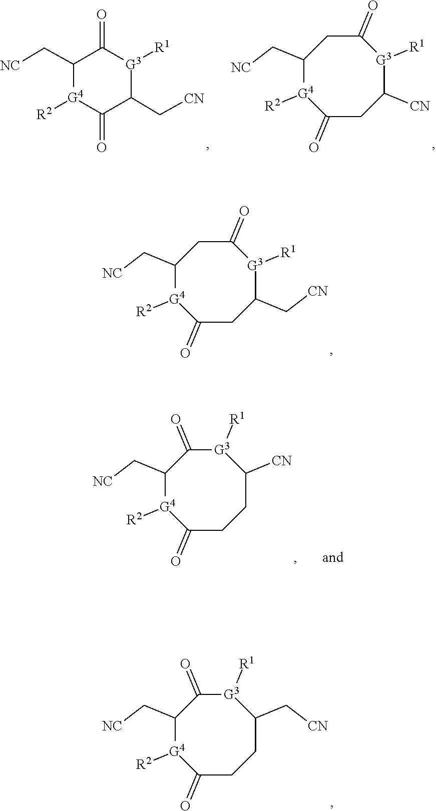

wherein G³, G⁴, R¹, and R² are as defined above.

In embodiments, the present disclosure provides a heteropolymer, wherein the heteropolymer is prepared by a process comprising polymerizing:

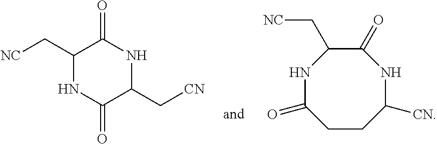 [SMILES: N#CCC1NC(=O)C(CC#N)NC1=O ; N#CCC1NC(=O)CCC(C#N)NC1=O]

In embodiments, the heteropolymers of the present disclosure are cross-linked polymers comprising two or more homopolymers, for example:

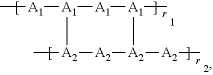

wherein A₁ is a monomer of Formula (I), A₂ is a second monomer of Formula (I) distinct from A₁, and r₁ and r₂ are each independently an integer in the range of 3 to 10,000.

In embodiments, one or more compounds of Formula (I) or Formula (II) (i.e., monomers) are polymerized with one or more additional monomers to form a heteropolymer of the present disclosure.

In embodiments, the present disclosure provides a heteropolymer, wherein the heteropolymer is prepared by a process comprising polymerizing:
a. one or more monomers of Formula (I):

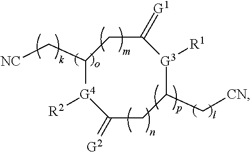

wherein G¹, G², G³, G⁴, R¹, R², k, 1, m, n, o, and p are as defined above, and
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the present disclosure provides a heteropolymer, wherein the heteropolymer is prepared by a process comprising polymerizing:
a. a compound of Formula (II):

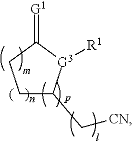

wherein G¹, G³, R¹, 1, m, n, and p are as defined above, and
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the present disclosure provides a heteropolymer, wherein the heteropolymer is prepared by a process comprising polymerizing:
a. a compound of Formula (II):

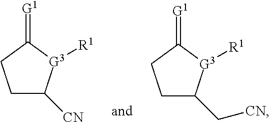

wherein G¹, G³, and R¹ are as defined above.
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the present disclosure provides a heteropolymer, wherein the heteropolymer is prepared by a process comprising polymerizing:
a. a compound of Formula (II):

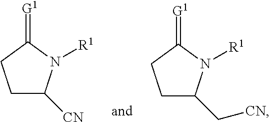

wherein G¹ and R¹ are as defined above.
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the present disclosure provides a heteropolymer, wherein the heteropolymer is prepared by a process comprising polymerizing:
a. a compound of Formula (II):

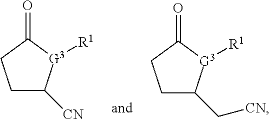

wherein G³ and R¹ are as defined above.
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the present disclosure provides a heteropolymer, wherein the heteropolymer is prepared by a process comprising polymerizing:
a.

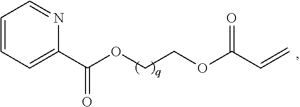

wherein q is an integer from 1-4, and
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the present disclosure provides a heteropolymer, wherein the heteropolymer is prepared by a process comprising polymerizing:
a.

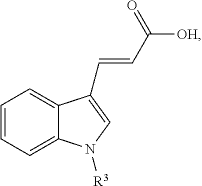

wherein R³ is H or alkyl, and
b. one or more monomers selected from the group consisting of ethylene oxide, methacrylate, a fluoro organic compound, acrylonitrile, styrene, vinyl pyrrolidone, pyrrole, acrylic acid, vinyl pyridine, and cyanoacrylate. In embodiments, the one or more monomers is ethylene oxide.

In embodiments, the heteropolymer electrolyte composition of the present disclosure is copolymer. In embodiments, the copolymer is a block copolymer.

In embodiments, the heteropolymers in the electrolyte composition have a uniform dispersity (D). In embodiments, the heteropolymers in the electrolyte composition have a non-uniform dispersity. In embodiments, D is from about 1 to about 20, e.g., about 1, about 2, about 3, about 4, about 5, about 6, about 7, about 8, about 9, about 10, about 11, about 12, about 13, about 14, about 15, about 16, about 17, about 18, about 19, or about 20.

In embodiments, the heteropolymer electrolyte is a solid polymer electrolyte (SPE). In embodiments, the heteropolymer electrolyte is a liquid polymer electrolyte.

### Electrolyte Compositions of the Present Disclosure

In embodiments, the present disclosure provides electrolyte compositions comprising the additives, homopolymers and/or heteropolymers of the present disclosure.

In embodiments, the present disclosure provides solid polymer electrolyte compositions comprising: a compound of Formula (I) (as described above), in combination with one or more conductive polymers or polymer electrolytes. In embodiments, the one or more conductive polymers is a homopolymer or a heteropolymer as described above.

In embodiments, the present disclosure provides solid polymer electrolyte compositions comprising: a compound of Formula (II) (as described above), in combination with one or more conductive polymers or polymer electrolytes.

In embodiments, the present disclosure provides solid polymer electrolyte compositions comprising a homopolymer or heteropolymer as described above. In embodiments, the present disclosure provides solid polymer electrolyte compositions comprising a homopolymer or heteropolymer (as described above), in combination with one or more conductive polymers or polymer electrolytes.

In embodiments, the one or more conductive polymers is selected from the group consisting of polyethylene oxide (PEO), poly(vinyl chloride) (PVC), poly(vinyl alcohol) (PVA), poly(vinylpyrrolidone) (PVP, poly(acrylic acid) (PAA), poly(acrylonitrile) (PAN), poly(vinylidene fluoride) (PVdF), poly(ethylmethacrylate) (PEMA), poly(methyl methacrylate) (PMMA), poly(vinylidenefluoride-hexafluoro propylene) (PVdF-HFP), poly (ε-caprolactone) (PCL), and chitosan. In embodiments, the one or more additional polymers is selected from the group consisting of PAN and PEO.

In embodiments, the one or more conductive polymers is an organic fluoropolymer. In embodiments, the fluoropolymer is selected from the group consisting of poly(vinylidene fluoride) (PVdF) and poly(vinylidenefluoride-hexafluoro propylene) (PVdF-HFP). In embodiments, the fluoropolymer is poly(vinylidene fluoride) (PVdF).

In embodiments, the one or more conductive polymers is selected from the group consisting of poly(ethylene oxide), a polyether, polyacrylonitrile, polystyrene, polyvinyl pyrrolidone, polypyrrole, polyacrylic acid, polyphenylene sulfide, polyether ether ketone, polyamines, polyimides, polyamides, and polycyanoacrylates.

In embodiments, the present disclosure provides composite polymer electrolytes comprising the additives, homopolymers and/or heteropolymers of the present disclosure. Composite polymer electrolytes, as they are known in the art, can be prepared and designed by techniques that include, but are not limited to blending, cross-linking polymer matrices, comb-branched copolymers, doping of nanomaterials, adding binary salt systems, incorporation of additives (e.g., plasticizers), impregnation with ionic liquids, and reinforcement with inorganic fillers and/or conductivity enhancers.

In embodiments, a composite polymer electrolyte of the present disclosure is prepared by cross-linking. In embodiments, a composite polymer electrolyte of the present disclosure is prepared by cross-linking a homopolymer and/or heteropolymer of the present disclosure with a polymer selected from the group consisting of poly(ethylene oxide), a polyether, polyacrylonitrile, polystyrene, polyvinyl pyrrolidone, polypyrrole, polyacrylic acid, polyphenylene sulfide, polyether ether ketone, polyamines, polyimides, polyamides, and polycyanoacrylates. In embodiments, a composite polymer electrolyte of the present disclosure is prepared by cross-linking a homopolymer and/or heteropolymer of the present disclosure with a polymer selected from the group consisting of polyethylene oxide (PEO), poly(vinyl chloride) (PVC), poly(vinyl alcohol) (PVA), poly(vinylpyrrolidone) (PVP, poly(acrylic acid) (PAA), poly(acrylonitrile) (PAN), poly(vinylidene fluoride) (PVdF), poly(ethylmethacrylate) (PEMA), poly(methyl methacrylate) (PMMA), poly(vinylidenefluoride-hexafluoro propylene) (PVdF-HFP), poly (ε-caprolactone) (PCL), and chitosan. In embodiments, a homopolymer and/or heteropolymer of the present disclosure is cross-linked with PEO or PAN. In embodiments, the cross-linked polymers of the present disclosure exhibit high ionic conductivity (>10⁻⁴ S/cm) and good mechanical strength (e.g., shear modulus >10⁻⁹ Pa). In embodiments, the improved properties are due to the amorphous nature (i.e., low crystallinity) of the CPE.

In embodiments, the present disclosure provides composite polymer electrolytes (CPE) prepared by blending. Polymer blending is a process of mixing at least two polymers that have no chemical bonding between them. In embodiments, blending, as disclosed herein, provides electrolyte materials that have superior properties compared to the individual components alone, for example improved physical properties (e.g., mechanical stability) and electrical properties (e.g., conductivity). In embodiments, a blended CPE has higher conductivity due to a lower amount of crystallinity. Decreasing the amount of crystallinity can result in the interactions between the polymers of the composite electrolyte being maximized.

In embodiments, a composite polymer electrolyte of the present disclosure is prepared by blending a homopolymer and/or heteropolymer of the present disclosure with a polymer selected from the group consisting of polyethylene oxide (PEO), poly(vinyl chloride) (PVC), poly(vinyl alcohol) (PVA), poly(vinylpyrrolidone) (PVP, poly(acrylic acid) (PAA), poly(acrylonitrile) (PAN), poly(vinylidene fluoride) (PVdF), poly(ethylmethacrylate) (PEMA), poly(methyl methacrylate) (PMMA), poly(vinylidenefluoride-hexafluoro propylene) (PVdF-HFP), poly (ε-caprolactone) (PCL), and chitosan. In embodiments, a composite polymer electrolyte of the present disclosure is prepared by blending a homopolymer and/or heteropolymer of the present disclosure with PAN or PEO.

The properties (e.g., ionic conductivity, crystallinity, mechanical stability, thermal stability, etc.) of the composite polymer electrolyte of the present disclosure can be tuned by adjusting the ratio of the homopolymer or heteropolymer to the additional polymer. In embodiments, the ratio of homopolymer or heteropolymer to the additional polymer is about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, or about 1:10, including all ratios and values therebetween. In embodiments, the ratio is about 1:1. In embodiments, the ratio is about 2:1. In embodiments, the ratio is about 1:2.

In embodiments, the CPE of the present disclosure comprises a solid polymer electrolyte. In embodiments, the CPE is a liquid polymer electrolyte.

In embodiments, the electrolyte compositions of the present disclosure further comprise one of more alkali metal salts. In embodiments, the alkali metal salt is a lithium salt or a sodium salt. In embodiments, the alkali metal salt is a lithium salt. In embodiments, the lithium salt is selected from the group consisting LiPF6, LiN(CF₃SO₂)₂, LiClO₄, LiCF₃SO₃, and Li₂B₄O₇, or combinations thereof. In embodiments, the salt is a non-metal salt. In embodiments, the non-metal salt is an ammonium salt. In embodiments, the ammonium salt is of CH₃COONH₄. In embodiments, a CPE doped with a salt exhibits better electrical stability and conductivity. In embodiments, the electrolyte compositions of the present disclosure are blended with any of the one or more alkali metal salts. In embodiments, the electrolyte compositions of the present disclosure are blended with a non-metal salt.

In embodiments, the electrolyte compositions of the present disclosure include one or more fillers or conductivity enhancers. In embodiments, the conductivity enhancer or filler is selected from the group consisting of succinonitrile, Al₂O₃, AlOOH, BaTiO₃, BN, LiN₃, LiAlO₂, lithium fluorohectorite, and fluoromica clay. In embodiments, the filler or conductivity enhancer is selected from the group consisting of silicon oxide (SiO₂), magnesium oxide (MgO), aluminum oxide (Al₂O₃), titanium oxide (TiO₂), zirconium oxide (ZrO₂), nanoclays, and talc, or combinations thereof. In embodiments, the nanoclay is selected from the group consisting of montmorillonite (MMT), kaolinite, and saponite. In embodiments, the filler is hydrophobic-fumed silica. In embodiments, the filler is a zeolite. In embodiments, the filler is a nanomaterial. In embodiments, the fillers are small, electrochemically inert particles. In embodiments, doping of fillers into CPEs improves ionic conductivity, mechanical stability, thermal stability, reduces crystallinity and the glass transition temperature, stabilizes the highly conductive amorphous phase, and provides superior interfacial stability in contact with various electrode materials. In embodiments, the fillers used in the present compositions reduce the crystallinity of polymers, hinder them from recrystallization or increase the degree of amorphicity, which leads to better ionic conductivity of the polymer. In embodiments, the filler or conductivity enhancer in the electrolyte composition is present in an amount of from about 5 to about 10% by weight, e.g., about 5%, about 6%, about 7%, about 8%, about 9%, or about 10%, including all ranges and values therebetween.

In embodiments, the electrolyte composition of the present disclosure further comprises one or more plasticizers. In embodiments, the plasticizer is selected from the group consisting of dimethyl carbonate (DMC), diocthyl adipate (DOA), dibutyl phthalate (DBP), diethyl carbonate (DEC), propylene carbonate (PC), ethylene carbonate (EC), glycol sulfite (GS), methylethylcarbonate (MEC), and butyrolactone (BL). In embodiments, plasticizers dissolve more charge carriers to increase the mobile medium for ions. In embodiments, the incorporation of plasticizers provide higher ionic conductivity and good thermal and mechanical stabilities.

In embodiments, the electrolyte compositions of the present disclosure further comprise a compound selected from the group consisting of poly(ethyleneoxide), methacrylate, a polyether, a fluoro organic compound, polyacrylonitrile, polystyrene, polyvinyl pyrrolidone, polypyrrole, polyacrylic acid, polyphenylene sulfide, polyether ether ketone, vinyl pyridine, polyamines, polyimides, polyamides, and polycyanoacrylates.

In embodiments, the electrolyte composition of the present disclosure further comprises a polymer selected from the group consisting of polypropylene, poly (2,6-dimethyl-1,4-phenylene oxide) (PXE), polyolefins, poly(cyclohexyl methacrylate), poly(cyclohexyl vinyl ether), poly(t-butyl vinyl ether), polyethylene, polynitriles, polysiloxanes, polyphosphazenes, polydiene, a polyether, polyphenylene sulfide, polyether ether ketone, polyamines, polyimides, and polyamides.

In embodiments of the present disclosure, the electrolyte composition further comprises an electrode stabilizing agent.

### Characteristics of Electrolyte Compositions of the Present Disclosure:

The electrolyte compositions of the present disclosure relate to improving and/or enhancing the size, charge rate, thermal stability, mechanical stability, ionic conductivity, power, energy density, and/or life span of the disclosed electrolyte compositions compared to existing technologies.

In embodiments, the electrolyte compositions of the present disclosure are characterized by an ionic conductivity from about 10⁻⁶ to about 10⁻² S/cm, e.g., about 10⁻⁶ S/cm, about 10⁻⁵ S/cm, about 10⁻⁴ S/cm, about 10⁻³ S/cm, or about 10⁻² S/cm, including all ranges and values therebetween. In embodiments, the ionic conductivity is from about 10⁻⁵ to about 10⁻³ S/cm. In embodiments, the ionic conductivity is from about 10⁻⁴ to about 10⁻³ S/cm. In embodiments, the ionic conductivity is greater than 10⁻⁴ S/cm. In embodiments, the ionic conductivity is greater than 10⁻³ S/cm. In embodiments, the electrolyte compositions are characterized by an ionic conductivity of 3.0×10⁻⁴ to 3.0×10⁻³ S/cm. In embodiments, the ionic conductivity is measured at room temperature.

In embodiments, the electrolyte compositions of the present disclosure are characterized by an electrochemical stability window of from about 1 to about 6 volts against Li/Li⁺, e.g., about 1 volt, about 2 volts, about 3 volts, about 4 volts, about 5 volts, or about 6 volts against Li/Li⁺, including all ranges and values therebetween.

In embodiments, the electrolyte compositions of the present disclosure do not ignite under the ASTM D4206 test conditions.

In embodiments, the electrolyte compositions of the present disclosure are stable at a temperature of about 30° C. to about 200° C., e.g., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., or about 200° C., including all ranges and values therebetween. In embodiments, the electrolyte composition is stable from about 30° C. to about 100° C. In embodiments, the electrolyte composition is stable at a temperature of about 75° C. to about 200° C. In embodiments, the electrolyte composition is stable at a temperature of about 100° C. to about 200° C. In embodiments, the electrolyte composition is stable at a temperature of about 125° C. to about 200° C. In embodiments, the electrolyte composition is stable at a temperature of about 150° C. to about 200° C. In embodiments, the electrolyte composition is stable at a temperature of about 175° C. to about 200° C. In embodiments, the electrolyte composition is stable from about −40° C. to about 170° C.

In embodiments of the present disclosure, the polymer of the electrolyte composition is characterized by an elastic modulus of at least 1×10⁷ Pa, at least 5×10⁷ Pa, at least 1×10⁸ Pa, at least 5×10⁸ Pa, at least 1×10⁹ Pa, or at least 5×10⁹ Pa. In embodiments, the elastic modulus of the polymer is measured by the ASTM D638 test. In embodiments, the ASTM D638 test is the ASTM D636-14 test.

In embodiments of the present disclosure, the polymer of the electrolyte composition is characterized by a shear modulus of at least 1×10⁹ Pa, at least 5×10⁹ Pa, at least 1×10⁸ Pa, at least 5×10⁸ Pa, at least 1×10⁷ Pa, or at least 1×10⁷ Pa. In embodiments, the electrolyte composition is characterized by a shear modulus of at least 1×10⁹ Pa.

In embodiments of the present disclosure, the electrolyte composition is characterized by a glass transition of less than about −50° C., less than about −45° C., less than about −40° C., less than about −35° C., or less than about −30° C. In embodiments, the glass transition temperature is less than about −40° C. In embodiments, the glass transition temperature is between about −40° C. and about −30° C., e.g., about −40° C., about −39° C., about −38° C., about −37° C., about −36° C., about −35° C., about −34° C., about −33° C., about −32° C., about −31° C., or about −30° C., including all ranges and values therebetween.

### Energy Storage Devices

In embodiments, the present disclosure provides a battery, comprising:
a. an anode;
b. a cathode; and
c. an electrolyte composition of the present disclosure operatively coupled with the anode and cathode.

In embodiments, the anode is a lithium metal anode or a carbon anode.

In embodiments, the cathode is an oxide cathode. In embodiments, the oxide cathode is selected from the group consisting of LiNiCoMnO₂ (NMC), LiFePO₄/C (LFP), LiNiCoAlO₂ (NCA), LiMn₂O₄ (LMO), LiNi0.5Mn1.5O₄ (LNMO), and LiCoO₂ (LCO). In embodiments, the cathode is a V₂O₅ cathode.

In embodiments, the battery is characterized by a specific energy density of at least about 290 Wh/kg, at least about 300 Wh/kg, at least about 320 Wh/kg, at least about 340 Wh/kg, at least about 380 Wh/kg, or at least about 400 Wh/kg. In another embodiment, the battery has a specific energy density in the range of about 295 Wh/kg to about 400 Wh/kg. In embodiments, the battery has a specific energy density in the range of about 320 Wh/kg to about 400 Wh/kg. In embodiments, the battery has a specific energy density in the range of about 360 Wh/kg to about 400 Wh/kg. In embodiments, the battery has a specific energy density of about 700 Wh/kg.

In embodiments, the battery is characterized by a specific energy of about 100 Wh/kg to about 750 Wh/kg, e.g., about 100 Wh/kg, about 125 Wh/kg, about 150 Wh/kg, about 175 Wh/kg, about 200 Wh/kg, about 225 Wh/kg, about 250 Wh/kg, about 275 Wh/kg, about 300 Wh/kg, about 325, about 350 Wh/kg, about 375 Wh/kg, about 400 Wh/kg, about 425 Wh/kg, about 450 Wh/kg, about 475 Wh/kg, about 500 Wh/kg, about 525 Wh/kg, about 550 Wh/kg, about 575 Wh/kg, about 600 Wh/kg, about 625 Wh/kg, about 650 Wh/kg, about 675 Wh/kg, about 700 Wh/kg, about 725 Wh/kg, or about 750 Wh/kg, including all ranges and values therebetween. In embodiments, the electrolyte composition is characterized by a specific energy of about 320 Wh/kg to about 700 Wh/kg.

In embodiments, the battery is characterized by an energy density of about 200 Wh/L to about 1200 Wh/L, e.g., about 200 Wh/L, about 250 Wh/L, about 300 Wh/L, about 350 Wh/L, about 400 Wh/L, about 450 about 500 Wh/L, about 550 Wh/L, about 600 Wh/L, about 650 Wh/L, about 700 Wh/L, about 750 Wh/L, about 800 Wh/L, about 850 Wh/L, about 900 Wh/L, about 950 Wh/L, about 1000 Wh/L, about 1050 Wh/L, about 1100 Wh/L, about 1150 Wh/L, or about 1200 Wh/L, including all ranges and values therebetween. In embodiments, the electrolyte composition is characterized by an energy density of about 700 Wh/L to about 1100 Wh/L.

In embodiments, the battery is characterized by a capacity of about 0.1 mAh to about 5 mAh, e.g., about 0.1 mAh, about 0.5 mAh, about 1 mAh, about 1.5 mAh, about 2 mAh, about 2.5 mAh, about 3 mAh, about 3.5 mAh, about 4 mAh, about 4.5 mAh, or about 5 mAh, including all ranges and values therebetween. In embodiments, the capacity of the electrolyte composition is greater than about 1 Ah, greater than about 2 Ah, greater than about 3 Ah, greater than about 4 Ah, or greater than about 5 Ah, including all ranges and values therebetween.

In embodiments of the present disclosure, the battery is characterized by a Pₘₐₓ of 1 kW to about 20 kW, e.g., about 1 kW, about 2 kW, about 3 kW, about 4 kW, about 5 kW, about 6 kW, about 7 kW, about 8 kW, about 9 kW, about 10 kW, about 11 kW, about 12 kW, about 13 kW, about 14 kW, about 15 kW, about 16 kW, about 17 kW, about 18 kW, about 19 kW, or about 20 kW, including all ranges and values therebetween. In embodiments, the Pₘₐₓ is at least 8 kW. In embodiments, the Pₘₐₓ is greater than 8 kW.

In embodiments of the present disclosure, the electrolyte composition is characterized by an electrochemical window (EW) in the range of about 3 V to about 6 V, e.g., about 3 V, about 3.2 V, about 3.4 V, about 3.6 V, about 3.8 V, about 4 V, about 4.2 V, about 4.4 V, about 4.6 V, about 4.8 V, about 5 V, about 5.2 V, about 5.4 V, about 5.6 V, about 5.8 V, or about 6 V, including all ranges and values therebetween. In embodiments, the electrochemical window of the electrolyte composition ranges from about 3 V to about 5 V. In embodiments, the electrochemical window of the electrolyte composition ranges from about 4 V to about 6 V.

In embodiments, the battery is a rechargeable battery.

In embodiments, the battery has a high capacity retention as exhibited by an 85% of retention after 100 number of cycles, an 85% of retention after 500 number of cycles, an 85% of retention after 800 number of cycles, or an 85% of retention after 1000 number of cycles. In embodiments, the battery has a high capacity retention as exhibited by a 90% of retention after 100 number of cycles, a 90% of retention after 500 number of cycles, a 90% of retention after 800 number of cycles, or a 90% of retention after 1000 number of cycles.

In embodiments of the present disclosure, the battery is a solid state battery.

In embodiments, the present disclosure provides a capacitor, comprising an electrolyte composition of the present disclosure. In embodiments, the capacitor is a supercapacitor. In embodiments, the supercapacitor is a double-layer capacitor, a pseudocapacitor, or a hybrid capacitor (i.e., a combination of double-layer and pseudocapacitors).

### Methods of Preparing Additives of the Present Disclosure:

In one aspect, the present disclosure provides methods of preparing a Compound of Formula (I) or a Compound of Formula (II).

In embodiments, a Compound of Formula (I) or Formula (II) is prepared by reaction with a nitrile-functional acid. In embodiments, the nitrile-functional acid is selected from the group consisting of:

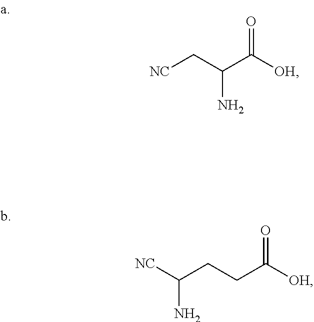 [SMILES: N#CCC(N)C(=O)O ; N#CC(N)CCC(=O)O]

or mixtures thereof.

In embodiments, the nitrile-functional acid is produced by fermentation of bioengineered microbes. In embodiments, the bioengineered microbes are derived from gram negative bacteria, gram positive bacteria, Ascomycota, or fungi.

### NUMBERED EMBODIMENTS OF THE DISCLOSURE

In addition to the disclosure above, the Examples below, and the appended claims, the disclosure sets forth the following numbered embodiments.
1. An electrolyte composition comprising:
   a compound of Formula (I):

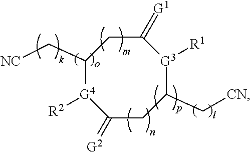

wherein
i. G¹ and G² are independently selected from the group consisting of O, S, Se, NH, and PH;
ii. G³ and G⁴ are independently selected from the group consisting of N and P;
iii. R¹ and R² are independently selected from the group consisting of H, alkyl, cycloalkyl, alkenyl, cycloalkenyl, aryl, alkylenearyl, heteroaryl, alkyleneheteroaryl;
iv. k and l are independently integers ≥0;
v. m and n are independently selected from 0, 1, 2, 3, 4 and 5; and
vi. o and p are independently selected from 1, 2, 3, 4 and 5.
2. The electrolyte composition of embodiment 1, wherein G¹ and G² are O.
3. The electrolyte composition of embodiment 1 or 2, wherein G³ and G⁴ are N.
4. The electrolyte composition of any one of embodiments 1-3, wherein R¹ and R² are independently selected from the group consisting of H and alkyl.
5. The electrolyte composition of any one of embodiments 1-4, wherein k and 1 are independently selected from 0 and 1.
6. The electrolyte composition of any one of embodiments 1-5, wherein m and n are 0.
7. The electrolyte composition of any one of embodiments 1-5, wherein m is 0 and n is 2.
8. The electrolyte composition of embodiment 1, wherein the compound of Formula (I) is selected from the group consisting of.

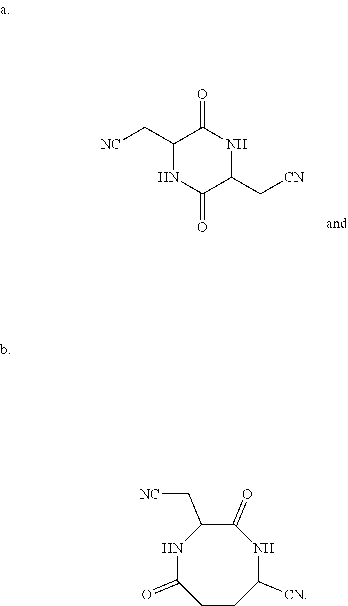 [SMILES: N#CCC1NC(=O)C(CC#N)NC1=O ; N#CCC1NC(=O)CCC(C#N)NC1=O]

9. An electrolyte composition comprising:
   a compound of Formula (II):

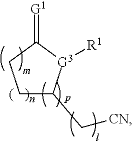

wherein
i. G¹ is selected from the group consisting of O, S, Se, NH, and PH;
ii. G³ is selected from the group consisting of N and P;
iii. R¹ is selected from the group consisting of H, alkyl, cycloalkyl, alkenyl, cycloalkenyl, aryl, alkylenearyl, heteroaryl, alkyleneheteroaryl;
iv. l is an integer ≥0;
v. m and n are independently selected from 1, 2, 3, 4 and 5; and
vi. p is selected from 1, 2, 3, 4 and 5.
10. The electrolyte composition of embodiment 9, wherein G¹ is O.
11. The electrolyte composition of embodiment 9 or 10, wherein G³ is N.
12. The electrolyte composition of any one of embodiments 9-11, wherein R¹ is selected from the group consisting of H, alkyl and alkenyl.
13. The electrolyte composition of any one of embodiments 9-12, wherein 1 is 0.
14. The electrolyte composition of any one of embodiments 9-13, wherein m and n are 1.
15. The electrolyte composition of any one of embodiments 9-14, wherein p is 1.
16. The electrolyte composition of embodiment 9, wherein the compound of Formula (II) is selected from the group consisting of:

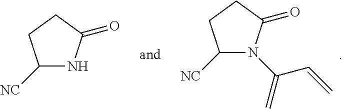

17. An electrolyte composition comprising a polymer prepared by a process comprising polymerizing a compound of Formula (I):

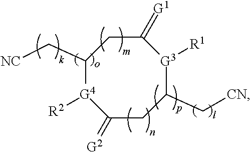

wherein
i. G¹ and G² are independently selected from the group consisting of O, S, Se, NH, and PH;
ii. G³ and G⁴ are independently selected from the group consisting of N and P;
iii. R¹ and R² are independently selected from the group consisting of H, alkyl, cycloalkyl, alkenyl, cycloalkenyl, aryl, alkylenearyl, heteroaryl, alkyleneheteroaryl;
iv. k and l are independently integers ≥0;
v. m and n are independently selected from 0, 1, 2, 3, 4 and 5; and
vi. o and p are independently selected from 1, 2, 3, 4 and 5.
18. The electrolyte composition of embodiment 17, wherein G¹ and G² are O.
19. The electrolyte composition of embodiment 17 or 18, wherein G³ and G⁴ are N.
20. The electrolyte composition of any one of embodiments 17-19, wherein R¹ and R² are independently selected from the group consisting of H and alkyl.
21. The electrolyte composition of any one of embodiments 17-20, wherein k and l are independently selected from 0 and 1.
22. The electrolyte composition of any one of embodiments 17-21, wherein m and n are 0.
23. The electrolyte composition of any one of embodiments 17-21, wherein m is 0 and n is 2.
24. The electrolyte composition of embodiment 17, wherein the compound of Formula (I) is selected from the group consisting of:

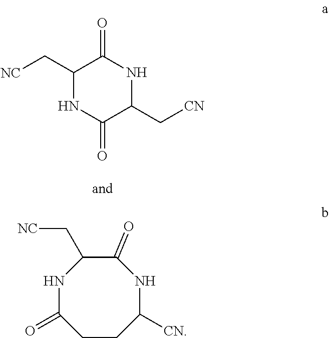 [SMILES: N#CCC1NC(=O)C(CC#N)NC1=O ; N#CCC1NC(=O)CCC(C#N)NC1=O]

25. An electrolyte composition comprising a polymer prepared by a process comprising polymerizing a compound of Formula (II):

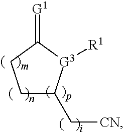

wherein
i. G¹ is selected from the group consisting of O, S, Se, NH, and PH;
ii. G³ is selected from the group consisting of N and P;
iii. R¹ is selected from the group consisting of H, alkyl, cycloalkyl, alkenyl, cycloalkenyl, aryl, alkylenearyl, heteroaryl, and alkyleneheteroaryl;
iv. l is an integer ≥0;
v. m and n are independently selected from 1, 2, 3, 4 and 5; and
vi. p is selected from 1, 2, 3, 4 and 5.
26. The electrolyte composition of embodiment 25, wherein G¹ is O.
27. The electrolyte composition of embodiment 25 or 26, wherein G³ is N.
28. The electrolyte composition of any one of embodiments 25-27, wherein R¹ is selected from the group consisting of H, alkyl and alkenyl.
29. The electrolyte composition of any one of embodiments 25-28, wherein 1 is 0.
30. The electrolyte composition of any one of embodiments 25-29, wherein m and n are 1.
31. The electrolyte composition of any one of embodiments 25-30, wherein p is 1.
32. The electrolyte composition of embodiment 31, wherein the compound of Formula (II) is selected from the group consisting of:

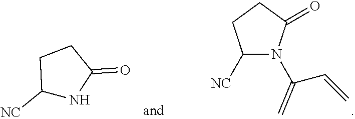

33. The electrolyte composition of any one of embodiments 17-32, wherein the compound of Formula (I) or compound of Formula (II) is copolymerized with a compound selected from the group consisting of ethylene oxide, methacrylate, a polyether, a fluoro organic compounds, acrylonitrile, styrene, vinyl pyrrolidone, pyrrole, acrylic acid, polyphenylene sulfide, polyether ether ketone, vinyl pyridine, polyamines, polyimides, polyamides, and cyanoacrylate.
34. The electrolyte composition of any one of embodiments 1-33, further comprising a compound selected from the group consisting of poly(ethylene oxide), methacrylate, a polyether, a fluoro organic compound, polyacrylonitrile, polystyrene, polyvinyl pyrrolidone, polypyrrole, polyacrylic acid, polyphenylene sulfide, polyether ether ketone, vinyl pyridine, polyamines, polyimides, polyamides and polycyanoacrylates.
35. The electrolyte composition of any one of embodiments 1-34, further comprising an alkali metal salt.
36. The electrolyte composition of embodiment 35, wherein the alkali metal salt is selected from the group consisting of a lithium salt and a sodium salt.
37. The electrolyte composition of any one of embodiments 1-36, further comprising an electrode stabilizing agent.
38. The electrolyte composition of any one of embodiments 1-37, further comprising a conductivity enhancer or filler.
39. The electrolyte composition of embodiment 38, wherein the conductivity enhancer or filler is selected from the group consisting of succinonitrile, Al₂O₃, AlOOH, BaTiO₃, BN, LiN₃, LiAlO₂, lithium fluorohectorite, and fluoromica clay.
40. The electrolyte composition of any one of embodiments 1-39, wherein the composition is a solid.
41. The electrolyte composition of any one of embodiments 1-40, wherein the composition is a liquid.
42. The electrolyte composition of any one of embodiments 1-41, wherein the electrolyte composition has an ionic conductivity of 3.0×10⁻⁴ to 3.0×10⁻³ (S/cm).
43. The electrolyte composition of any one of embodiments 1-42, wherein the electrolyte composition has an electrochemical stability window of from about 1 to about 6 volts against Li/Li⁺.
44. The electrolyte composition of any one of embodiments 1-43, wherein the electrolyte composition does not ignite under the ASTM D4206 test conditions.
45. The electrolyte composition of any one of embodiments 1-44, wherein the electrolyte composition is stable at a temperature of about 30° C. to about 200° C.
46. The electrolyte composition of any one of embodiments 1-45, wherein electrolyte composition is characterized by an elastic modulus of at least 1×10⁷ Pa, at least 5×10⁷ Pa, at least 1×10⁸ Pa, at least 5×10⁸ Pa, at least 1×10⁹ Pa, or at least 5×10⁹ Pa.
47. A battery, comprising:
   a. an anode;
   b. a cathode; and
   c. an electrolyte composition of any one of embodiments 1-46 operatively coupled with the anode and cathode.
48. The battery of embodiment 47, wherein the battery has a specific energy density of at least about 290 Wh/kg, at least about 300 Wh/kg, at least about 320 Wh/kg, at least about 340 Wh/kg, at least about 380 Wh/kg, or at least about 400 Wh/kg.
49. The battery of any one of embodiments 47-48, wherein the battery has a specific energy density of about 700 Wh/kg.
50. The battery of any one of embodiments 47-49, wherein the battery is a rechargeable battery.
51. The battery of any one of embodiments 47-49, wherein the battery has a high capacity retention as exhibited by an 85% of retention after 100 number of cycles, an 85% of retention after 500 number of cycles, an 85% of retention after 800 number of cycles, or an 85% of retention after 1000 number of cycles.
52. A capacitor, comprising an electrolyte composition of any one of embodiments 1-46.
53. The capacitor of embodiment 52, wherein the capacitor is a supercapacitor.
54. A compound selected from the group consisting of:

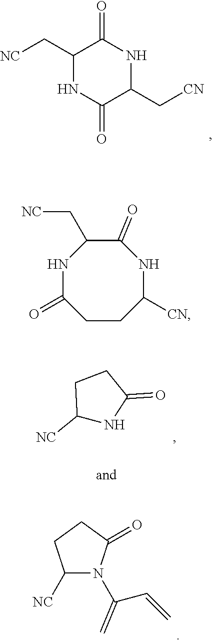

55. The compound of embodiment 54, prepared by the reaction of a nitrile-functional acid selected from the group consisting of:

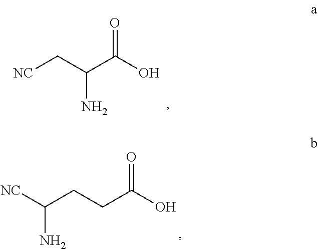 [SMILES: N#CCC(N)C(=O)O ; N#CC(N)CCC(=O)O]

or mixtures thereof.
56. The compound of embodiment 55, wherein the nitrile-functional acid is produced by fermentation with bioengineered microbes.
57. The compound of embodiment 56, wherein the bioengineered microbes are derived from gram negative bacteria, gram positive bacteria, Ascomycota, or fungi.

1. An electrolyte composition comprising:
a compound of Formula (I): 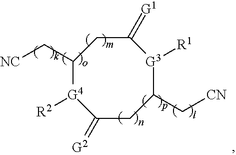
wherein
i. G¹ and G² are independently selected from the group consisting of O, S, Se, NH, and PH;
ii. G³ and G⁴ are independently selected from the group consisting of N and P;
iii. R¹ and R² are independently selected from the group consisting of H, alkyl, cycloalkyl, alkenyl, cycloalkenyl, aryl,
alkylenearyl, heteroaryl, alkyleneheteroaryl;
iv. k and l are independently integers ≥0;
v. m and n are independently selected from 0, 1, 2, 3, 4 and 5; and
vi. o and p are independently selected from 1, 2, 3, 4 and 5.

2. The electrolyte composition of claim 1, wherein G¹ and G² are O.

3. The electrolyte composition of claim 1 or 2, wherein G³ and G⁴ are N.

4. The electrolyte composition of any one of claims 1-3, wherein R¹ and R² are independently selected from the group consisting of H and alkyl.

5. The electrolyte composition of any one of claims 1-4, wherein k and l are independently selected from 0 and 1.

6. The electrolyte composition of any one of claims 1-5, wherein m and n are 0.

7. The electrolyte composition of any one of claims 1-5, wherein m is 0 and n is 2.

8. The electrolyte composition of claim 1, wherein the compound of Formula (I) is selected from the group consisting of:

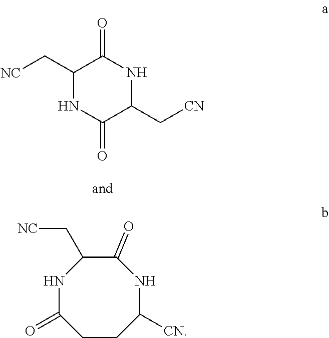 [SMILES: N#CCC1NC(=O)C(CC#N)NC1=O ; N#CCC1NC(=O)CCC(C#N)NC1=O]

9. An electrolyte composition comprising:
a compound of Formula (II): 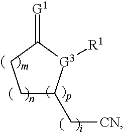
wherein
i. G¹ is selected from the group consisting of O, S, Se, NH, and PH;
ii. G³ is selected from the group consisting of N and P;
iii. R¹ is selected from the group consisting of H, alkyl, cycloalkyl, alkenyl, cycloalkenyl, aryl, alkylenearyl, heteroaryl,
alkyleneheteroaryl;
iv. l is an integer ≥0;
v. m and n are independently selected from 1, 2, 3, 4 and 5; and
vi. p is selected from 1, 2, 3, 4 and 5.

10. The electrolyte composition of claim 9, wherein G¹ is O.

11. The electrolyte composition of claim 9 or 10, wherein G³ is N.

12. The electrolyte composition of any one of claims 9-11, wherein R¹ is selected from the group consisting of H, alkyl and alkenyl.

13. The electrolyte composition of any one of claims 9-12, wherein 1 is 0.

14. The electrolyte composition of any one of claims 9-13, wherein m and n are 1.

15. The electrolyte composition of any one of claims 9-14, wherein p is 1.

16. The electrolyte composition of claim 9, wherein the compound of Formula (II) is selected from the group consisting of:

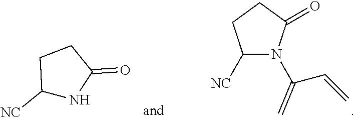

17. An electrolyte composition comprising a polymer prepared by a process comprising polymerizing a compound of Formula (I): 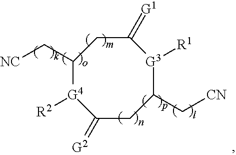
wherein
i. G¹ and G² are independently selected from the group consisting of O, S, Se, NH, and PH;
ii. G³ and G⁴ are independently selected from the group consisting of N and P;
iii. R¹ and R² are independently selected from the group consisting of H, alkyl, cycloalkyl, alkenyl, cycloalkenyl, aryl,
alkylenearyl, heteroaryl, alkyleneheteroaryl;
iv. k and l are independently integers ≥0;
v. m and n are independently selected from 0, 1, 2, 3, 4 and 5; and
vi. o and p are independently selected from 1, 2, 3, 4 and 5.

18. The electrolyte composition of claim 17, wherein G¹ and G² are O.

19. The electrolyte composition of claim 17 or 18, wherein G³ and G⁴ are N.

20. The electrolyte composition of any one of claims 17-19, wherein R¹ and R² are independently selected from the group consisting of H and alkyl.

21. The electrolyte composition of any one of claims 17-20, wherein k and l are independently selected from 0 and 1.

22. The electrolyte composition of any one of claims 17-21, wherein m and n are 0.

23. The electrolyte composition of any one of claims 17-21, wherein m is 0 and n is 2.

24. The electrolyte composition of claim 17, wherein the compound of Formula (I) is selected from the group consisting of:

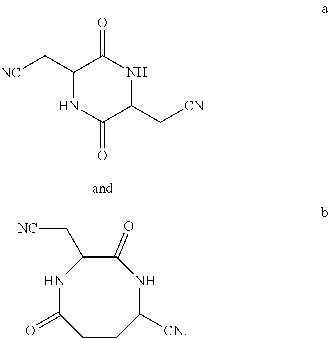 [SMILES: N#CCC1NC(=O)C(CC#N)NC1=O ; N#CCC1NC(=O)CCC(C#N)NC1=O]

25. An electrolyte composition comprising a polymer prepared by a process comprising polymerizing a compound of Formula (II): 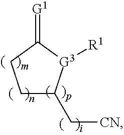
wherein
i. G¹ is selected from the group consisting of O, S, Se, NH, and PH;
ii. G³ is selected from the group consisting of N and P;
iii. R¹ is selected from the group consisting of H, alkyl, cycloalkyl, alkenyl, cycloalkenyl, aryl, alkylenearyl, heteroaryl, and alkyleneheteroaryl;
iv. l is an integer ≥0;
v. m and n are independently selected from 1, 2, 3, 4 and 5; and
vi. p is selected from 1, 2, 3, 4 and 5.

26. The electrolyte composition of claim 25, wherein G¹ is O.

27. The electrolyte composition of claim 25 or 26, wherein G³ is N.

28. The electrolyte composition of any one of claims 25-27, wherein R¹ is selected from the group consisting of H, alkyl and alkenyl.

29. The electrolyte composition of any one of claims 25-28, wherein 1 is 0.

30. The electrolyte composition of any one of claims 25-29, wherein m and n are 1.

31. The electrolyte composition of any one of claims 25-30, wherein p is 1.

32. The electrolyte composition of claim 31, wherein the compound of Formula (II) is selected from the group consisting of:

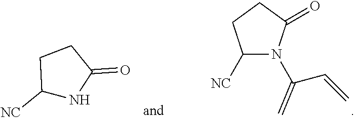

33. The electrolyte composition of any one of claims 17-32, wherein the compound of Formula (I) or compound of Formula (II) is copolymerized with a compound selected from the group consisting of ethylene oxide, methacrylate, a polyether, a fluoro organic compounds, acrylonitrile, styrene, vinyl pyrrolidone, pyrrole, acrylic acid, polyphenylene sulfide, polyether ether ketone, vinyl pyridine, polyamines, polyimides, polyamides, and cyanoacrylate.

34. The electrolyte composition of any one of claims 1-33, further comprising a compound selected from the group consisting of poly(ethylene oxide), methacrylate, a polyether, a fluoro organic compound, polyacrylonitrile, polystyrene, polyvinyl pyrrolidone, polypyrrole, polyacrylic acid, polyphenylene sulfide, polyether ether ketone, vinyl pyridine, polyamines, polyimides, polyamides and polycyanoacrylates.

35. The electrolyte composition of any one of claims 1-34, further comprising an alkali metal salt.

36. The electrolyte composition of claim 35, wherein the alkali metal salt is selected from the group consisting of a lithium salt and a sodium salt.

37. The electrolyte composition of any one of claims 1-36, further comprising an electrode stabilizing agent.

38. The electrolyte composition of any one of claims 1-37, further comprising a conductivity enhancer or filler.

39. The electrolyte composition of claim 38, wherein the conductivity enhancer or filler is selected from the group consisting of succinonitrile, Al₂O₃, AlOOH, BaTiO₃, BN, LiN₃, LiAlO₂, lithium fluorohectorite, and fluoromica clay.

40. The electrolyte composition of any one of claims 1-39, wherein the composition is a solid.

41. The electrolyte composition of any one of claims 1-40, wherein the composition is a liquid.

42. The electrolyte composition of any one of claims 1-41, wherein the electrolyte composition has an ionic conductivity of 3.0×10⁴ to 3.0×10⁻³ (S/cm).

43. The electrolyte composition of any one of claims 1-42, wherein the electrolyte composition has an electrochemical stability window of from about 1 to about 6 volts against Li/Li⁺.

44. The electrolyte composition of any one of claims 1-43, wherein the electrolyte composition does not ignite under the ASTM D4206 test conditions.

45. The electrolyte composition of any one of claims 1-44, wherein the electrolyte composition is stable at a temperature of about 30° C. to about 200° C.

46. The electrolyte composition of any one of claims 1-45, wherein electrolyte composition is characterized by an elastic modulus of at least 1×10⁷ Pa, at least 5×10⁷ Pa, at least 1×10⁸ Pa, at least 5×10⁸ Pa, at least 1×10⁹ Pa, or at least 5×10⁹ Pa.

47. A battery, comprising:
a. an anode;
b. a cathode; and
c. an electrolyte composition of any one of claims 1-46 operatively coupled with the anode and cathode.

48. The battery of claim 47, wherein the battery has a specific energy density of at least about 290 Wh/kg, at least about 300 Wh/kg, at least about 320 Wh/kg, at least about 340 Wh/kg, at least about 380 Wh/kg, or at least about 400 Wh/kg.

49. The battery of any one of claims 47-48, wherein the battery has a specific energy density of about 700 Wh/kg.

50. The battery of any one of claims 47-49, wherein the battery is a rechargeable battery.

51. The battery of any one of claims 47-49, wherein the battery has a high capacity retention as exhibited by an 85% of retention after 100 number of cycles, an 85% of retention after 500 number of cycles, an 85% of retention after 800 number of cycles, or an 85% of retention after 1000 number of cycles.

52. A capacitor, comprising an electrolyte composition of any one of claims 1-46.

53. The capacitor of claim 52, wherein the capacitor is a supercapacitor.

54. A compound selected from the group consisting of:

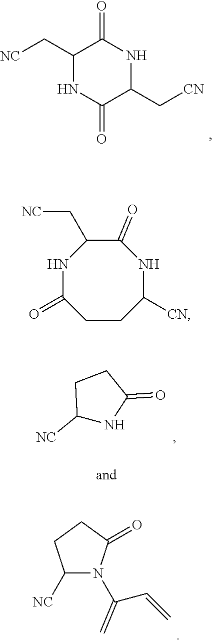

55. The compound of claim 54, prepared by the reaction of a nitrile-functional acid selected from the group consisting of: 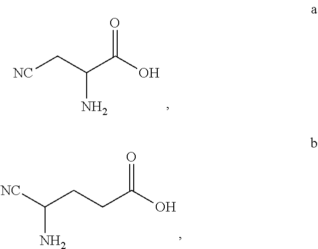 [SMILES: N#CCC(N)C(=O)O ; N#CC(N)CCC(=O)O]
or mixtures thereof.

56. The compound of claim 55, wherein the nitrile-functional acid is produced by fermentation with bioengineered microbes.

57. The compound of claim 56, wherein the bioengineered microbes are derived from gram negative bacteria, gram positive bacteria, Ascomycota, or fungi.
